(19) United States
(12) Patent Application Publication
(10) Pub. No.: US 2007/0143159 A1
(43) Pub. Date: Jun. 21, 2007

(54) System and method for outcomes-based delivery of services

(76) Inventors: Robin A. Robison Dillard, Englewood, NJ (US); Primelynn Cynthia Reyes, Silver Spring, MD (US); Sherwin Kendrick Meeker, Alexandria, VA (US); Steve Ohara Johnson, Redford, MI (US); James Richard Stevenson, Gaithersburg, MD (US); Beverly Otema Yirenkyi, Olney, MD (US)

Correspondence Address: IBM CORPORATION (RHF), C/O ROBERT H. FRANTZ, P. O. BOX 23324, OKLAHOMA CITY, OK, 73123, US

(21) Appl. No.: 11/304,943

(22) Filed: Dec. 16, 2005

(51) Int. Cl. G06F 9/44

(52) U.S. Cl. 705/7

(57) ABSTRACT

A systems-assisted method for defining and managing a public value network according to one or more desired outcomes of the public value network, which includes creating a public value network representation by defining participants in the network, relationships between the participants, and a desired outcome the network, assigning a maturity level value to each relationship; establishing a network governance framework; specifying the capabilities of said public value network; calculating a capabilities maturity index according to the defined relationships, relationship maturity levels, and capabilities; and creating visualizations displayed to a user representing the network, the relationships, and the maturity levels.

### INCORPORATION BY REFERENCE

The document entitled “Component business modeling: A private banking example” published by IBM Advanced Business Institute and downloadable from http://www-03<dot>ibm<dot>com/ibm/palisades/abinsight/issues/2004-Jul/article-1. html, is hereby incorporated by reference in its entirety.

Additionally, Government Accountability Office document GAO-05-830T entitled “21ST CENTURY CHALLENGES—Transforming Government to Meet Current and Emerging Challenges”, testimony by David M. Walker, Comptroller General of the United States before the Subcommittee on the Federal Workforce and Agency Organization, Committee on Government Reform, House of Representatives, statement released Wednesday, Jul. 13, 2005, is hereby incorporated by reference in its entirety.

### BACKGROUND OF THE INVENTION

1. Field of the Invention

This invention relates to assessing motivations and corresponding relationships of participants in an ecosystem—a value network—within which strategies are collaboratively developed, relationships and innovation are fostered, and capabilities are designed and coordinated to achieve a specific shared outcome and/or corresponding change in focus, operations, and, especially governance.

2. Background of the Invention

Yesterday, management philosophies, organizational structures and public value delivery models were based on linear and hierarchical notions of control. These linear and hierarchical organizational and business models were, and in some cases, can still be found throughout the economy (public, private and civil society).

Businesses and governments around the world are increasingly faced with challenges not easily addressed by a command and control model. More and more organizations face a global market with multiple partners, using alternative delivery channels, new and innovative techniques and cost cutting measures to be effective and compete on a global scale. Their success not only depends on a dynamic business and organizational structure that quickly adapts to changing business needs, but also on the success of their interactions with the public sector and civil society.

For example, David M. Walker, Comptroller General of the United States, Government Accountability Office (“GAO”), testified before the Subcommittee on the Federal Workforce and Agency Organization, Committee on Government Reform, House of Representatives, regarding changing challenges to operation of government functions, which were reported in document number GAO-05-830T, entitled “Transforming Government to Meet Current and Emerging Challenges”. To summarize the present inventors' understanding of this statement, the GAO apparently has recently devised criteria for evaluating government programs like:
(a) Why did the federal government initiate this program and what was the government trying to accomplish?
(b) Have there been significant changes in the country or the world that relate to the reason for initiating it?
(c) Are there outcome-based measures? If not, why? If there are outcome-based measures, how successful is it based on these measures?
(d) Is it well targeted to those with the greatest needs and the least capacity to meet those needs?
(e) Is it using the most cost-effective or net beneficial approaches when compared to other tools and program designs?
(f) Is the responsible entity employing prevailing best practices to discharge its responsibilities and achieve its mission?

Given this picture, there are a number of important questions that need to be addressed. Among them are the following, using the health care crisis as an example:
(a) How can we perform a systematic reexamination of our current health care system? For example, could public and private entities work jointly to establish formal reexamination processes that would:
   (1) define and update as needed a minimum core of essential health care services;
   (2) ensure that all Americans have access to the defined minimum core services;
   (3) allocate responsibility for financing these services among such entities as government, employers, and individuals; and
   (4) provide the opportunity for individuals to obtain additional services at their discretion and cost?
(b) How can we make our current Medicare and Medicaid programs financially sustainable? For example, should the eligibility requirements (e.g., age, income requirements) for these programs be modified?
(c) How can health care tax incentives be designed to encourage employers and employees to better control health care cost? For example, should tax preferences for health care be designed to cap the health insurance premium amount that can be excluded from an individual's taxable income?
(d) How can technology be leveraged to reduce costs and enhance quality while protecting patient privacy?

In today's environment these conditions are compelling fundamental and systemic change in how business and government operate. The Business Model Revolution, driven by the need to be competitive, is compelling greater focus on core business competencies. The World Wide Web Revolution, with global access and connectivity, is compelling greater collaboration. And, the Digital Revolution, with its pervasive information infrastructure, is compelling greater insight. Together, they are the eye of a perfect storm for a new level of innovation and the catalyst for systemic political, economic and cultural change

Within these sweeping changes and demands for new ways to operate, the need to increase public value has not diminished. In fact, the changes brought about in e-commerce, increased mobility and connectivity have made demands on government even greater. Many government entities are faced with growing missions and service delivery requirements with fewer and fewer resources to get the job done—all in an environment where value is limited by current governance models.

Therefore, there is a need in the art for a system and method to, systematically, identify, visualize, analyze and take advantage of opportunities for collaboration and shared value in a networked organization of resources, capabilities, and relationships.

### SUMMARY OF THE INVENTION

The present invention emphasizes the combination of collaborative innovation and leadership as the basic ingredients for discovering, harnessing and directing untapped or new value to contribute to a shared outcome.

The present invention provides a method and system for increasing the visibility of public value networks by mapping public issues against the public policy system to articulate the desired, and shared Public Outcome(s). This includes identifying value network participants, analyzing roles and competencies, and allocating resources and capabilities across the public value network to achieve Outcomes-based Delivery (“OBD”). According to another aspect of the present invention, relationships between participants in the network that may not have been considered previously are illuminated.

The present invention enables developing a Network Governance Framework that fosters effective relationships, transparency, and shared accountability towards creating public value. OBD demonstrates the derivative nature of capabilities in a Capability Hierarchy so that strategic direction can be linked to the network business model and interdependencies understood.

According to yet another aspect of the present invention, it allows the systematic assessment of Network Capability Maturity, such that when network roles, capabilities and their maturity are uniformly understood, matching requirements to network resources is enhanced.

### BRIEF DESCRIPTION OF THE DRAWINGS

The following detailed description when taken in conjunction with the figures presented herein provide a complete disclosure of the invention.

FIG. 1 sets forth a high-level logical process according to the invention for gathering necessary information, defining a public value network, and generating the visualization information and displays.

FIGS. 2a and 2b show a generalized computing platform architecture, and a generalized organization of software and firmware of such a computing platform architecture.

FIG. 3a sets for a logical process to deploy software to a client in which the deployed software embodies the methods and processes of the present invention.

FIG. 3b sets for a logical process to integrate software to other software programs in which the integrated software embodies the methods and processes of the present invention.

FIG. 3c sets for a logical process to execute software on behalf of a client in an on-demand computing system, in which the executed software embodies the methods and processes of the present invention.

FIG. 3d sets for a logical process to deploy software to a client via a virtual private network, in which the deployed software embodies the methods and processes of the present invention.

FIG. 4 illustrates the differences and association between some typical public issues, some relevant policy areas and corresponding desirable public outcomes.

FIG. 5a provides, for reference, a particular format of illustration of a hierarchical network as defined by Albert Laszlo Barabasi.

FIG. 5b illustrates in a general sense a simple public value network having a desired public outcome (55) and corresponding network outcome (56), provided by network participants from the public sector (53), civil sector (54), and private sector (52).

FIG. 6 illustrates the hierarchical nature of the framework concept for an example top-level public outcome of “safe transportation”.

FIG. 7 illustrates the hierarchical visualization of the derivative nature of public value network outcomes per one aspect of the invention.

FIG. 8 provides an illustration such as that of FIG. 7, but annotated for a specific public issue scenario.

FIG. 9 provides a chart for illustration of how the invention promotes visualization of public value networks from just outputs to outcomes.

FIG. 10 shows details of assessment of the level of maturity of relationships within the public value network.

FIGS. 11a, 11b, and 11c show tabular methods for inputting or reviewing information on the parameters of public value network governance.

FIG. 12 shows a tabular method for input and display of public value network specific capability maturity assessment.

FIG. 13 shows an example public issue map as produced according to the invention.

FIG. 14 sets forth details of a logical process according to the invention for creating or revising a public issue map.

FIG. 15 shows details of a logical process according to the invention for assessing or revising a public value network's relationships' maturities.

FIG. 16 illustrates details of a logical process according to the invention for defining or revising a network governance framework.

FIG. 17 sets forth details of a logical process according to the invention for defining or revising a PVN's capabilities and the maturities of those capabilities.

FIG. 18 shows details of a logical process according to the invention for creating or updating an Outcomes-based Delivery Roadmap.

FIG. 19 provides an example Innovation Leadership Matrix.

FIG. 20a shows an illustrative Public Sector Planning Framework.

FIG. 20b shows a graphical representation of an Outcomes-based Delivery Roadmap display or printout; one output of the Public Sector Planning Framework.

### DESCRIPTION OF THE INVENTION

Changes in technology and governance expectations has wrought certain “revolutionary” conditions in the environment compelling fundamental change in ecosystems. Throughout the following disclosure, we will employ terms regarding change such as “optimize” and “minimize” in a relative sense, not an absolute sense. For example, if a particular aspect of a network is “optimized” by applying the invention, that shall be interpreted to mean that the particular aspect is substantially improved relative to its state without use of the invention. Such a term should not be construed to mean that such an aspect is necessarily brought to its absolute optimal point or value.

“Outcomes-based Delivery” (“OBD”), as we will use the term in the present disclosure, relates to assessing the drivers, purpose and related offerings of entities that contribute to achieving public outcomes. It includes analyzing the relationships and capabilities of existing and potential participants (across sectors)—in a public value network in a process or project usually by members of the public sector—and illuminates innovative possibilities for achieving public outcomes and designing effective public value networks.

“Public value”—the increased confidence that comes with achieving public outcomes—is shared by all sectors. The public sector, particularly government, plays the key role in stewarding the planning, creation and ultimately the delivery of public value. But public outcomes” cannot be delivered by one organization, rather, they are “contributed to” by a network of participants across sectors—a “public value network”.

Public Value Networks typically emerge around outcomes, and visibility is key. The system of public policy provides an important lens from which to view the public value network because it spans all sectors; thus a policy perspective is important. The public value network is cross-sectoral in nature. While outcomes are hierarchical in nature, the corresponding delivery mechanisms (delivery network) are not. When discussing the network of participants that emerge to deliver on a specific outcome (or set of related outcomes), it is important to realize that they are completely dynamic.

The participants in the network may or may not have established relationships implying a “relationship maturity” that is important to understand. Having insight into the maturity of relationships informs the type of governance framework needed to facilitate an effective public value network. In addition, participants in the network play specific roles and have corresponding competencies to enable them to fulfill those roles by delivering services required by the network.

Some competencies are core to the role, others are not. Nonetheless, the corresponding capabilities in the network must build on competency and “interoperate” to contribute to the public outcome. A participant may or may not possess the capabilities internally that are needed to completely fulfill the role. They may rely on others for help. Understanding the derivative nature and maturity of capabilities (can be viewed in the capability hierarchy) can help organizations make targeted decisions (a manageable scope).

As provided by the present invention, “visibility” of these “relationships” by those who are defining or managing these networks, participants, and relationships, allow strategic choices to be made, and allows the participants to position their organizations for success in an environment that has fundamentally changed

The present invention provides the following components, methods, or steps to address several key issues in public value network management:

Defining Public Outcomes and Why They Are Important. Public outcomes are high-level desired results that are in the interest of the public good. When they are achieved, confidence is increased. Public outcomes are common to all sectors. Achieving public outcomes is dependent on the contribution of many participants in the public value network. Achieving public outcomes is why the Public Sector—particularly government—is in business. The present invention provides a Public Issue Map to address defining public outcomes and their relative importance and impact, as described in more detail in the following paragraphs.

Applying a ‘Public Policy’ perspective. The policy environment underpins the activity of public, civic, commercial and social institutions, and significantly influences why value networks come together to produce or yield public outcomes. According to one aspect of a preferred embodiment of the present invention, while participants who are accountable for formulating and implementing public policy will continue to execute that role, a public policy perspective is employed to provide a useful “lens” for viewing interrelationships within the Public Sector and across sectors through provision of a Public Sector Planning Framework, as described in more detail in the following paragraphs.

Defining Public Value Networks and How They Are Formed and Organized. A Public Value Network, also referred to as a Value Net, is a system of interconnected relationships that consists of all the constituencies that directly and indirectly influence the creation, distribution, exchange, and destruction of public value within the network. Public Value networks emerge in support of a public outcome and differ from value chains because they include multiple and cross-sector value-creating relationships and corresponding capabilities. The present invention assists in understanding and establishing public value networks and their formation by providing a Network Governance Framework, as described in more detail in the following paragraphs.

Understanding Network Participant Relationship Maturity. The relationships of Network participants are interdependent with different levels of maturity. Participants with relatively mature relationships tend to have stronger, more complementary systems for business interaction that optimize their contribution towards achieving the public outcome, including compatible processes, infrastructure, application interfaces. The present invention addresses understanding network relationship maturity by providing the aforementioned Network Governance Framework, as well as an analysis and visualization of Public Value Capability Maturity, as described in more detail in the following paragraphs.

Visualization of Capability Maturity. Not only is maturity of relationships important to the ability of a public value network to achieve public outcomes, but the maturity of each participant's capabilities to play their role in the network drives the ability to achieve public outcomes. According to an aspect of the present invention, capabilities within a public value network are visualized as a hierarchy because they are derivative in nature, which allows “componentization” of the capabilities, and linking between capabilities. Capability maturity matters because it facilitates the determination of optimal points for intervention, and potential opportunities for a service provider, while providing insights into risk. The present invention addresses visualization and understanding of capability maturities in a public value network by providing a Capability Maturity Hierarchy and Model, as described in more detail in the following paragraphs.

Designing Effective Public Value Networks. Using the method or system of the present invention helps network participants focus on core roles and related competencies needed to fulfill their missions, develop outcomes-based strategies, create outcomes-based public value networks, leverage competencies and relationships, and manage networks. Optimizing roles, responsibilities and relationships add to the design aspect of the present invention. Public Value Network Creators and Managers must also address Network Governance to embed sustainable mechanisms for promoting transparency, fulfilling legal responsibilities and assuring accountability. Additionally, ways are illuminated for these creators and managers to become responsive to their environments, proactively meeting the changing needs of constituents. Further, use of the present invention enables them to see how they can adapt their cost structures to more variable and flexible constructs, and assists them in identifying solutions that enable greater resiliency in their operations. The present invention assists in creation of value for public value network creators and managers through providing the aforementioned Public Sector Planning Framework.

Identifying and Seizing Opportunities for Participants in Public Value Networks. Use of the present invention provides insight into public networks and why they emerge, and clarifies the role of the Public Sector in a meaningful business context for the emerging On Demand computing environment in the Public Sector. Not only can relationships between institutions be “drawn” using the framework by the invention, but it also maps out roles and related specific capabilities so that strengths and opportunities, redundancies and inefficiencies within the network become obvious. The framework allows the threading together of offerings from a particular public value network participant such as International Business Machines (“IBM”)™, such as IBM's Component Business Modeling (“CBM”) services, in a relevant manner that creates value-added, and expands the network participants' options for realizing both individual and shared value. The insight provided uncovers, shapes and drives opportunities for innovation and growth, new relationships, new and increasingly cross-sector markets, new clients and new capabilities. The present invention assists in identifying and producing opportunities and solutions for participants in public value network to provide value-added services, as a result of innovations in or changes to processes, organization (design and change management), information, applications and technologies, (or combinations thereof through the aforementioned Public Sector Planning Framework.

OBD Framework Concept

To understand the present invention, it is important to distinguish between “public issues” and “public outcomes” since one compels action and the other represents the desired result from a network. The three “sectors”—public, private, civil society—are interdependent. For example, consider the critical role that the public sector plays in an economy or jurisdiction. Taking a “public sector perspective” provides a compelling and powerful view of all sectors because the public sector establishes environments within which the other sectors operate.

A public issue, however, is a motivating force that drives the Public Sector to act, through establishing policies, laws, and regulations, on behalf of the public good. Public issues “point” to desired public outcomes, where the public outcome is the desired result that is in the interest of the public good. The outcomes serve as catalysts for a new or modified public value network.

Typically, no single institution can achieve a given public outcome, but rather, stakeholders from all three sectors—public, private and civil society—are contributors to public outcomes. As such, public outcomes are common to all sectors.

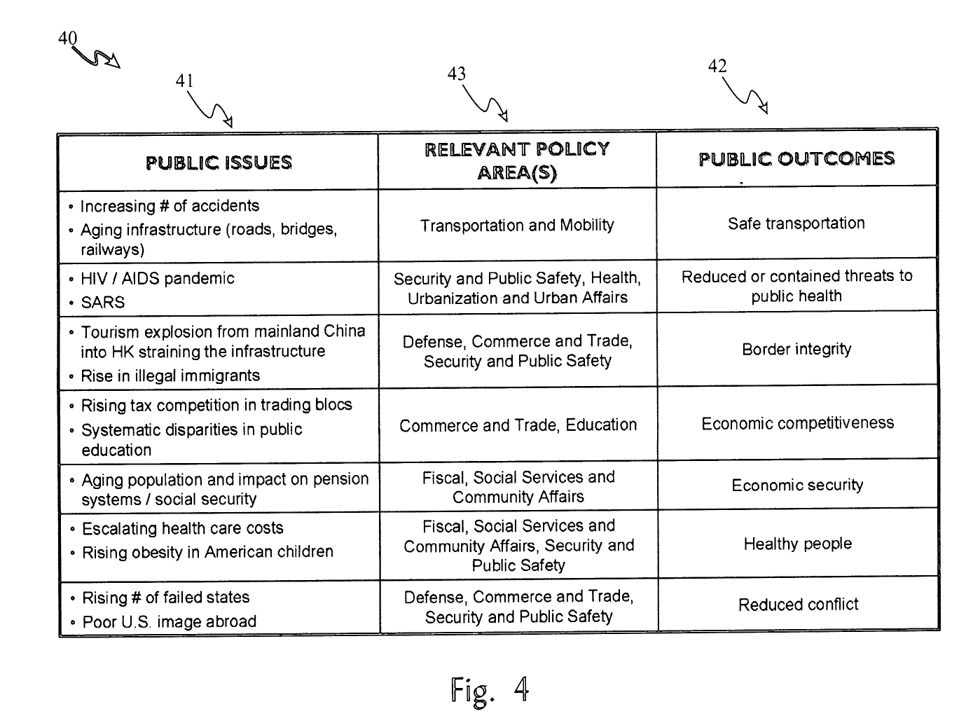

FIG. 4 illustrates (40) in tabular form the differences and correspondence between some typical public issues (41), relevant policy areas (43), and corresponding desirable public outcomes (42).

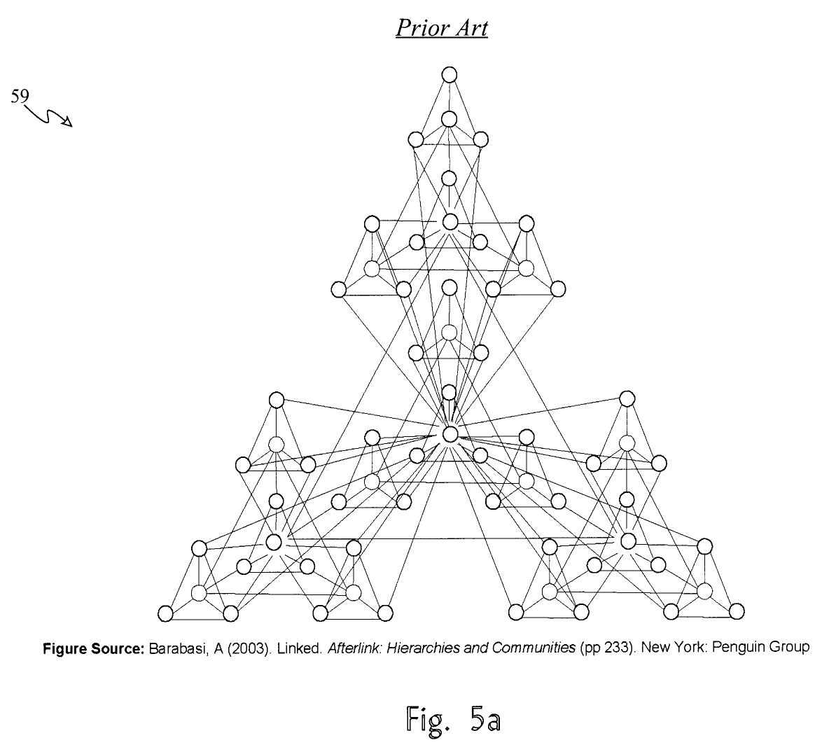

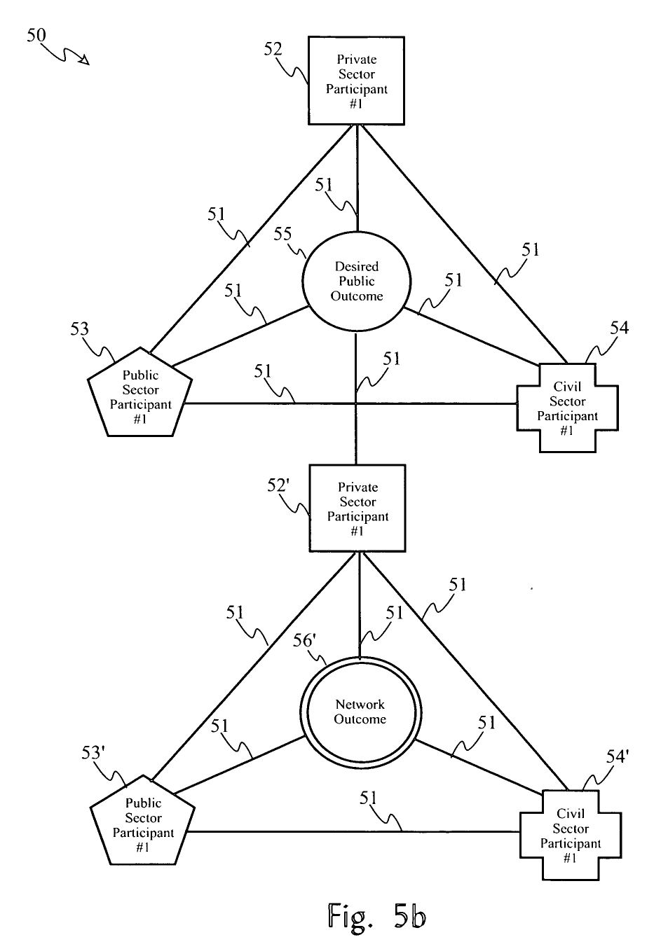

FIG. 5a shows a format of illustration for a hierarchical network as proposed by Albert-Lazlo Barabasi in his book “Linked. Afterlink: Hierarchies and Communities”, published in 2003 by the Penguin Group, New York (see page 233 especially). This illustration has been adopted and further adapted to represent the hierarchical and derivative nature of public outcomes, which drives the corresponding delivery network.

FIG. 5b illustrates in a general sense an adaptation of a Barabasi-type diagram according to the present invention, in which a simple public value network has a desired public outcome (55) and corresponding network outcome (56), provided by network participants from the public sector (53), civil sector (54), and private sector (52). The links (51) represent relationships between the participants in the network, while the symbols (52, 52′, 53, 53′, 54, 54′) at the edges of the network diagram represent the contributions or roles each participant plays in the network. At the center of the networks are the outcomes (55, 56) for which the networks exist. In this illustration, different shapes of icons (e.g. rectangles/squares, pentagons, and cross-shaped polygons) have been used to denote different types or classes of parties in the networks in order to comply with patent drawing standards. However, in an alternate embodiment, the icons are shown in different colors corresponding to classes of parties in the network.

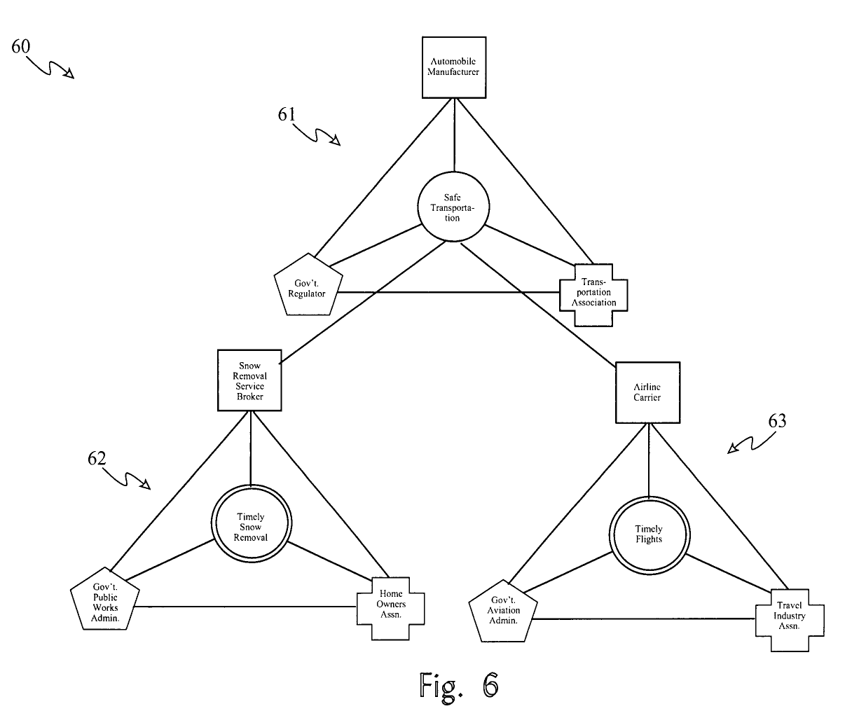

FIG. 6 illustrates the hierarchical nature (61) of the framework concept for an example top-level public outcome “safe transportation”, which is part of a top-level public value network (61) including a government regulator, a transportation industry association, and an automobile manufacturer, as illustrated by the present invention. Linked to the safe transportation public value network (61) are networks for timely snow removal (62) and timely air flights (63), each having their own participants.

Visualization of the Derivative Nature of Outcomes in a Public Value Network

Achieving public outcomes depends on the integration of other intermediate outcomes, greater collaboration and coordination. As such, public value network outcomes are both hierarchical and derivative in nature. They imply how a public value network, which can be made up of other value networks, comes together. They also uncover the capabilities required by the delivery model so that each institution contributes meaningfully to the desired outcome. Capabilities of the participants in the public value network are also derivative in nature.

To assist in establishing and managing public value networks in a manner that compels and optimizes such integration, collaboration and coordination, the present invention provides a visualization of the derivative nature of outcomes in the network.

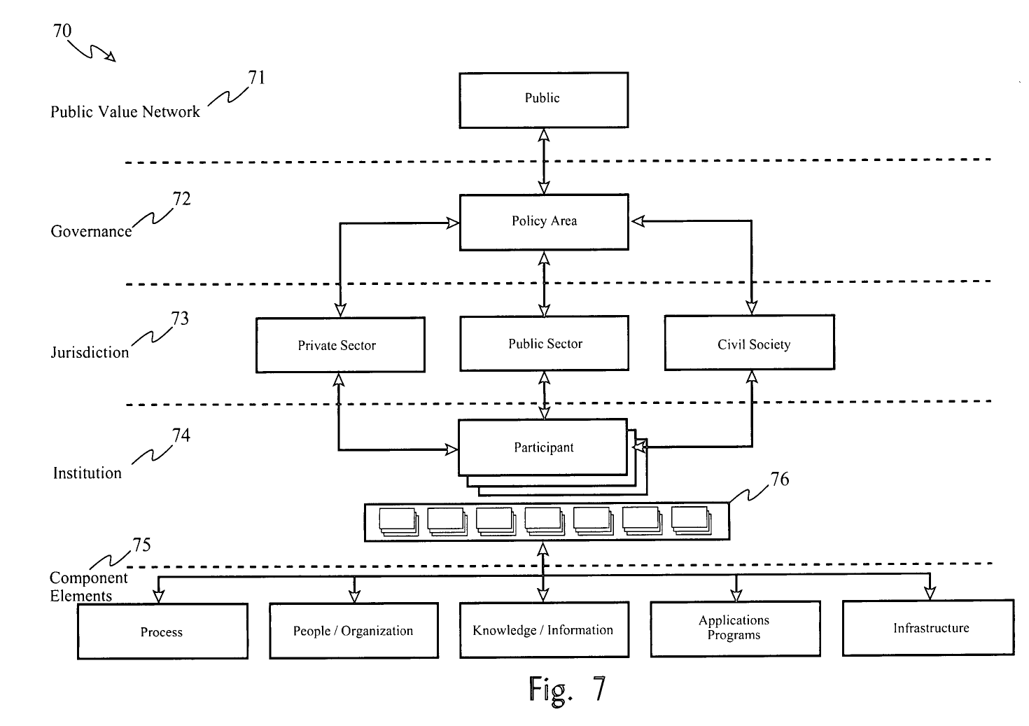

According to one aspect of the present invention, the derivative nature of the outcomes of a public value network or set of networks is visualized by a public value network design assistance system, the elements of which are also derivative in nature (70) as shown in FIG. 7, wherein a top-most level (71) represents the ultimate public outcome of the public value network. The next lower level (72) represents the scope of governance therein that is comprised of the relevant policy areas in the public value network (71). In the middle layer (73), the relevant policy areas within the scope of governance (72) are bounded by the jurisdiction (73) within which all sectors—the public, private and civil society sectors—of the public value network (71) interrelate and interact. Each sector of the jurisdiction layer (73), is represented by the next layer—institutions (74)—wherein one or more network participants provide and/or operate one or more relevant CBM business components (76). Each CBM business component (76) is comprised of distinct but interdependent component elements (75), such as processes to be followed or application programs to be employed in the operation of the public value network. Outcomes are achieved at every level, contributing—positively, neutrally, or negatively—upwards to the desired outcome of the public value network.

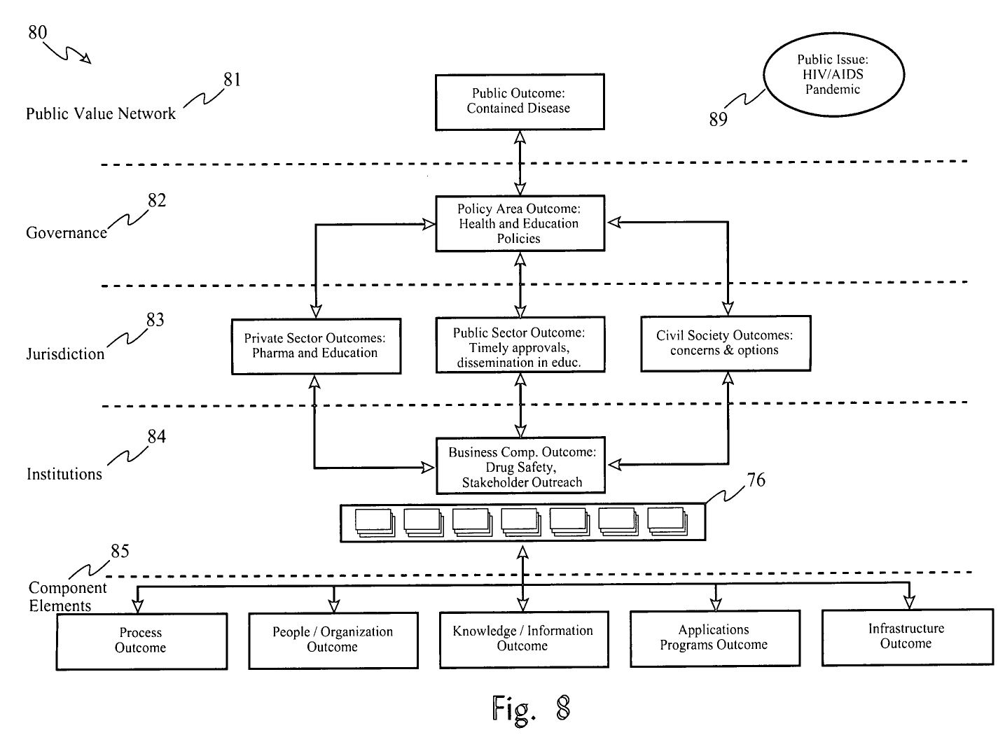

Turning to FIG. 8, the visualization is shown for an example specific public issue: an HIV/AIDS pandemic (89). In this example, the public value network (81) includes the public outcome to contain the disease. Governance (82) of this network falls within at least two areas of policy: (a) government health policy to reduce infection rates, and (b) education policy to increase awareness of the public health risk.

In the jurisdiction layer (83) of the visualization in this example, the private sector outcomes are identified for (a) the pharmaceutical industry to attain acceptable or higher profits, increased brand recognition, and reduced cost of treatment production; and (b) for the educational industry to increased brand recognition for specialized training for diagnosis techniques, drug applications, and treatment protocols. The public sector outcomes are identified as: (a) timely approval of new or existing treatment protocols, and (b) assuring that the latest certified research makes its way quickly to the curriculum of public education system. Additionally in this layer, civil society outcomes are identified as (a) making sure that emerging concerns heard from the public and professionals, and (b) education options are made available to the public and to professionals in the health care field.

In the component layer (84) of this example, two business components have been identified: (a) drug safety assurance for increased testing and quality and capacity optimization, and (b) a stakeholder outreach component having optimized costs of drug production and improved quality control.

A Policy-Perspective in Identifying Public Value Networks

A Public Policy Area is a category or subject area that organizes general principles and priorities around a set of related topics or subjects that guide and focus the formulation, prioritization, planning, management, resource allocation and administration of public policy and public decisions. The following categories seem to be reflected in governments globally, in one form or another: Agriculture, Accountability Framework (Regulations and Standards), Arts and Cultural Heritage, Commerce and Trade, Defense, Education, Energy, Environment and Natural Resources, Fiscal, Health, Information and Communications, Justice, Labor, Legal Framework (Rule of Law), Monetary (or capital) System, Science, Security and Public Safety, Social Services and Community Affairs, Technology and Innovation, Transportation and Mobility, Urbanization and Urban Affairs.

A policy-driven perspective is useful because the policy environment underpins why value networks come together (outcomes) and influences the activity of institutions (public, commercial, social) within that environment. Policies are the “mechanisms” with which the Public Sector fulfills its mission to be Steward and Catalyst for the public good. The networked environment presents increasingly dynamic, interrelated public issues that demands greater focus, responsiveness, cost effectiveness, resiliency and transparency from the public policy system all at the same time in order to increase confidence.

Inherent in policy is a value system and related priorities for what is considered important by a government or a society. Public funding typically follows policy priorities across the government enterprise. With current practices (e.g. without the current invention), this leads often to focusing strictly on a specific agency's budget, which fosters a “false economy”, by not factoring in the interdependencies of policy administration and policy execution between agencies, and the commitment of resources in non-differentiating, commoditized areas, marginalizing or foregoing opportunities for realizing greater value or even distracting from the desired public value.

Extending Visualization of Public Value Networks to Outcomes

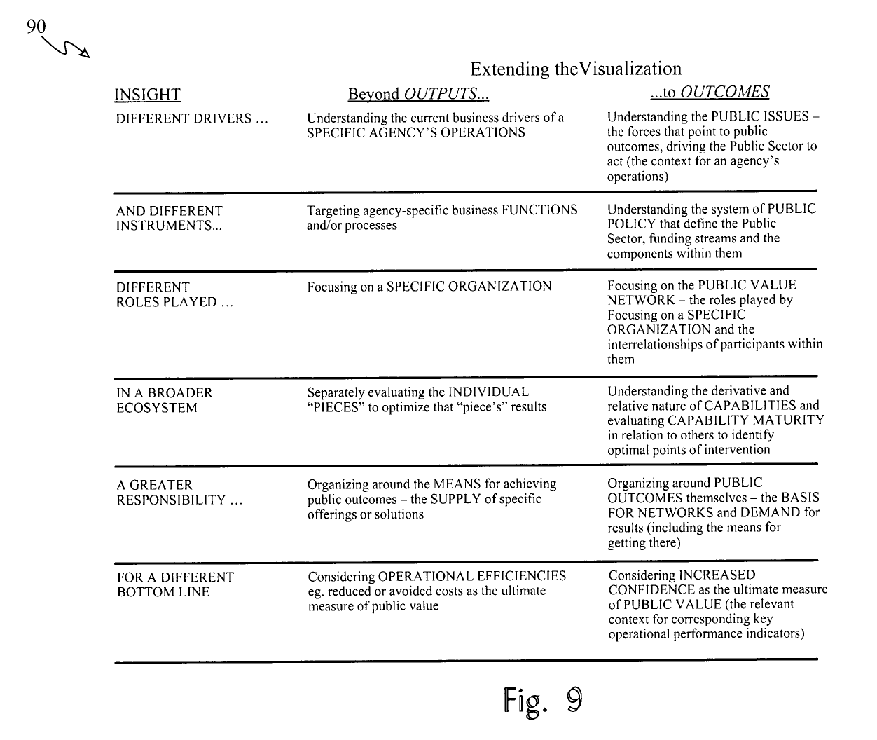

To understand the fundamental differences of the Public Sector, the present invention facilitates extending the visualization of public value networks from the traditional output-based view to a outcomes-based view, as shown (90) in FIG. 9. For example, in addition to understanding a specific government agency's operations, the current invention extends this to visualizing the public issues which drive that agency's existence as well as its current scope of operations. But this view is still limited, simplistic and unlike the dynamic environment faced by an agency. The present invention goes further to extend the view of a single agency to include the Public Value Networks within which this agency participates, how the agency fits in the public value network by defining its roles and responsibilities, how the agency interrelates with other participants by defining its competencies and related capabilities, and finally, what outcomes are of shared interest to agency and other network participants.

High-Level Components of OBD

The Outcomes-based Delivery (“OBD”) method and system of the present invention has several high-level components, each of which can be used or applied separately or in combination to achieve greater value:
(a) a Public Issue Map,
(b) a Network Governance Framework,
(c) a Public Value Capability Maturity Visualizer/Analyzer, and
(d) a Public Sector Planning Framework.

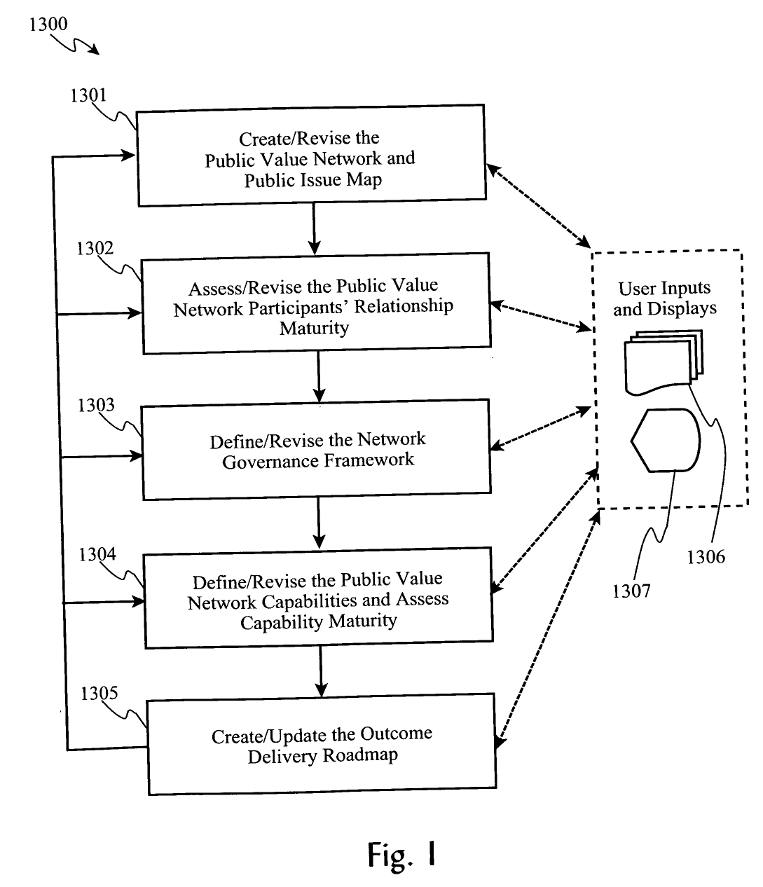

The process of the present invention can be generalized (1300) in the following phases, as shown in FIG. 1:
(1) Create a Public Issue Map (1301);
(2) Assess the Public Value Network Participants' Relationship Maturity (1302);
(3) Define the Network Governance Framework (1303);
(4) Define the Public Value Network Capabilities and Assess Capability Maturity (1304); and
(5) Create an Outcomes-based Delivery Roadmap (1305).

Throughout these phases of the process of the invention, certain inputs (1306) are collected from the user, and certain displays or visualizations (1307) of the information are generated for the user's review. Each phase can be repeated during planning, and throughout operation of the public value network, as needed in order to revise or update the network based upon changes in conditions, capabilities, participants, and desired outcomes.

Phase 1: Create a Public Issue Map

In this phase (1301), the invention makes the Public Value Network “visible” by defining and mapping a particular or specific public issue against the public policy system and to the desired public outcome. This optionally includes an environmental and public policy analysis, where relevant.

The primary set of network participants from all sectors, organized around policy area, is identified and described. The method provides a process for business leaders to “see” the set of network participants that interrelate to achieve a public outcome, to reach an agreement on the desired public outcome, and to identify shared and complementary benefits

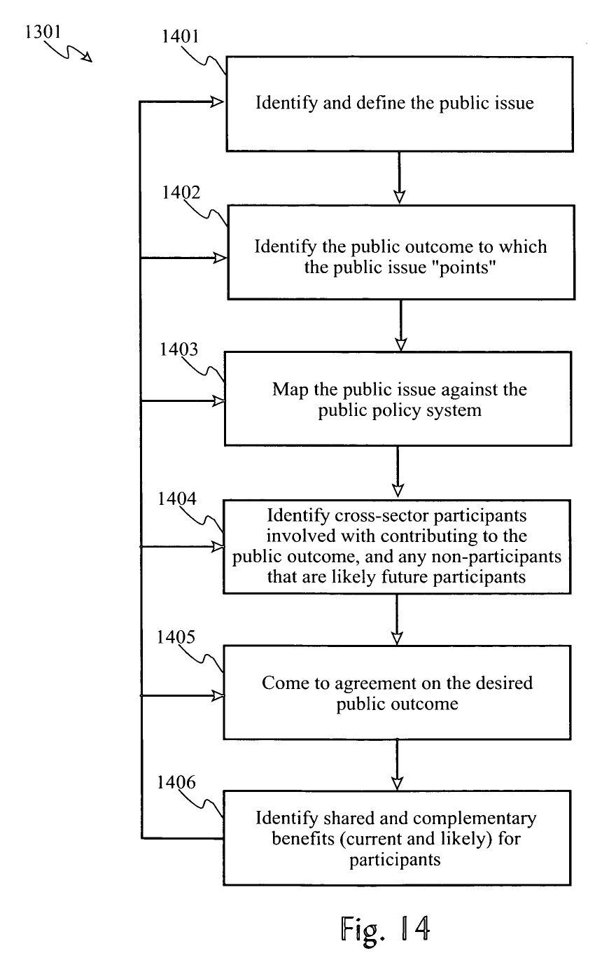

Turning to FIG. 14, a logical process according to the present invention to create a public issue map includes the following steps:
(a) identify and define the public issue (1401);
(b) identify the public outcome to which the public issue “points” (1402);
(c) map the public issue against the public policy system (1403);
(d) identify cross-sector participants involved with contributing to the public outcome (1404);
(e) identify cross-sector non-participants that are likely future participants (1404);
(f) reach agreement on the desired public outcome (1405); and
(g) identify shared and complementary benefits (current and likely) for participants (1406).

According to the present invention, all of these steps, save (f), are accomplished via a computer-aided graphical-based application program receiving input and definitions from a user, and providing any identified graphical illustrations or outputs to the user via a computer display, printed report, or equivalent.

Phase 2: Assess the Public Value Network Participants' Relationship Maturity

In this phase (1302) as shown in FIG. 1, the Public Value Network developed in Phase 1 is assessed to determine the roles that network participants currently and could or should play, along with a related optimal set of competencies.

The maturity of key relationships between participants and articulate participant issues and opportunities is identified in narrative form. These narratives form the basis for important conversations in order to build a foundation of trust among participants. The method of the invention particularly focuses on defining opportunities and roadblocks to collaboration and building transparency into the public value network.

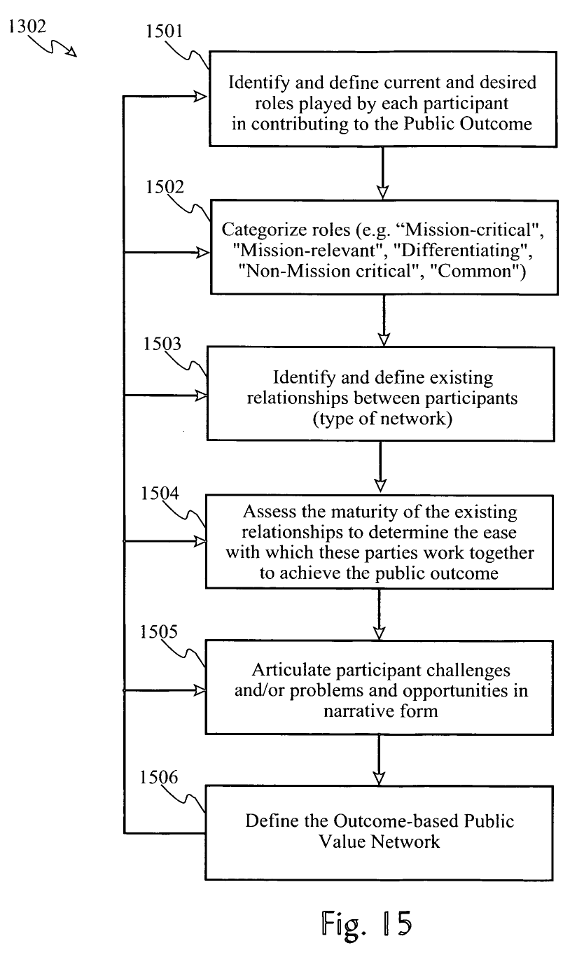

Turning to FIG. 15, a logical process according to the present invention to assess the public value network participants' relationship maturities includes the following steps:
(a) identify and define current and desired roles played by each participant in contributing to the Public Outcome (1501);
(b) categorize roles according to “Mission-critical”, “Mission-relevant”, “Differentiating”; “Non-Mission critical”, “Commoditized” (1502);
(c) identify and define existing relationships between participants (e.g. type of network) (1503);
(d) assess the maturity of the existing relationships to determine the ease with which these parties work together to achieve the public outcome (1504);
(e) articulate participant challenges, problems and opportunities in narrative form (1505); and
(f) define the Outcome-based Public Value Network (1506).

According to the present invention, all of these steps are accomplished via a computer-aided application program, receiving input and definitions from a user, and providing any identified graphical illustrations or outputs to the user via a computer display, printed report, or equivalent.

With special reference to step (c) regarding identifying relationship types, in one embodiment, the types of Public-Private Networks set forth by Stephen Goldsmith and William D. Eggers in “Governing by Network: The New Shape of the Public Sector” (The Brookings Institution, 2004) are used to describe types of relationships (e.g. ranking from less formal such as “ad hoc” to more formal such as “formal contractual”). The types of relationships influence the types of delivery networks (the business model by which services are delivered/exchanged) that contribute to the outcome. Other types may be identified and/or used, alternatively, as indicated by the particular network being established or managed.

Phase 3: Define the Network Governance Framework (1303)

As shown in FIG. 1, the next phase (1303) is based on the results from Phase 2, in which participants collaboratively develop shared guiding principles and high-level definitions of “what success looks like” from the network and individual participant perspectives.

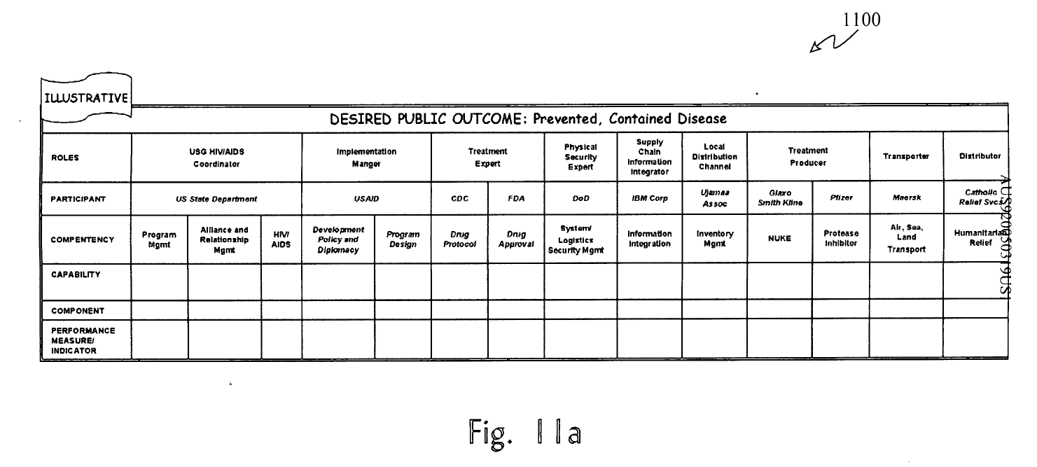

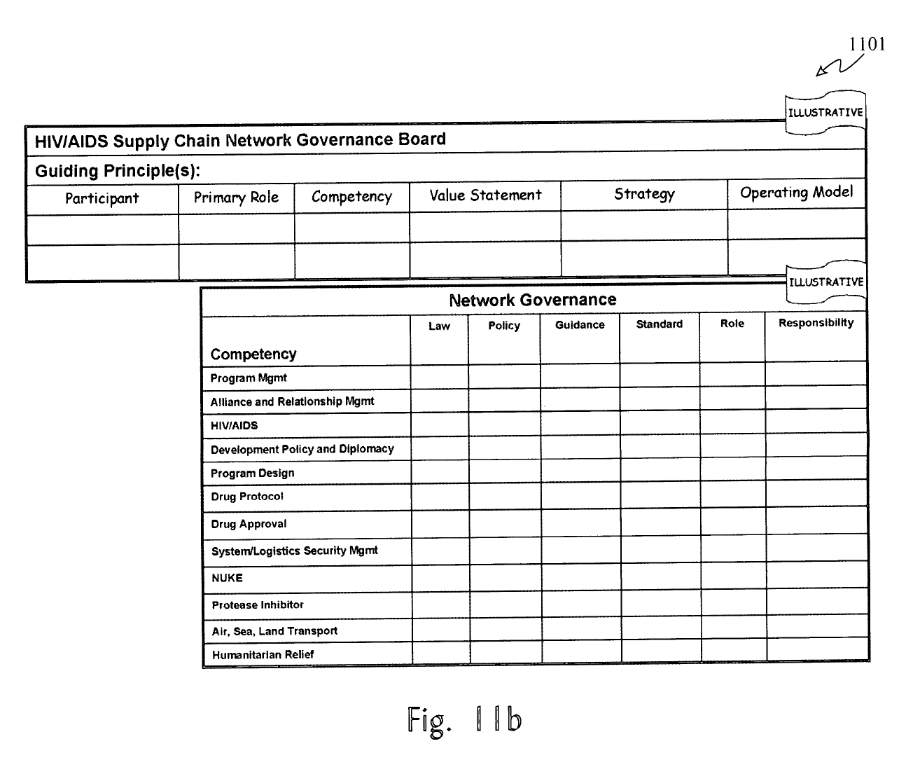

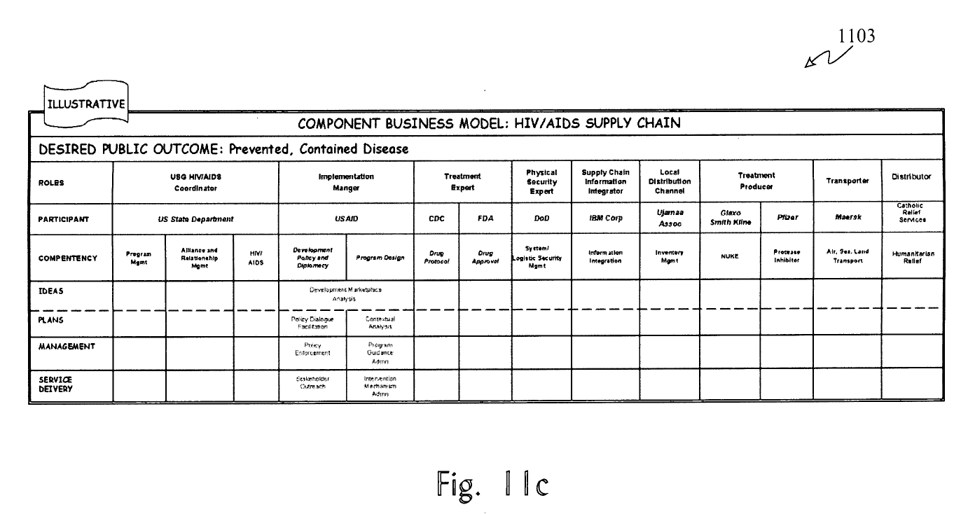

In this phase, a governing group is formalized to create the governance framework for the Public Value Network—competencies, structure, and operating model. The invention provides a forum where strategies are developed, prioritized, and further defined into actionable goals and objectives. The issues, opportunities and risks identified are resolved, realized and mitigated respectively. The method also facilitates the articulation of “value” statements from a public (collective) value and institutional (participant) value perspective to determine if and/or where value statements conflict. FIG. 11b shows (1101) a tabular format for collecting and displaying this information in this phase, such as an electronic form.

The governance framework establishes the minimum requirements for accountability based policy, process, organization, roles and responsibilities in a self-governed public value network and identifies ways for building and achieving innovation leadership.

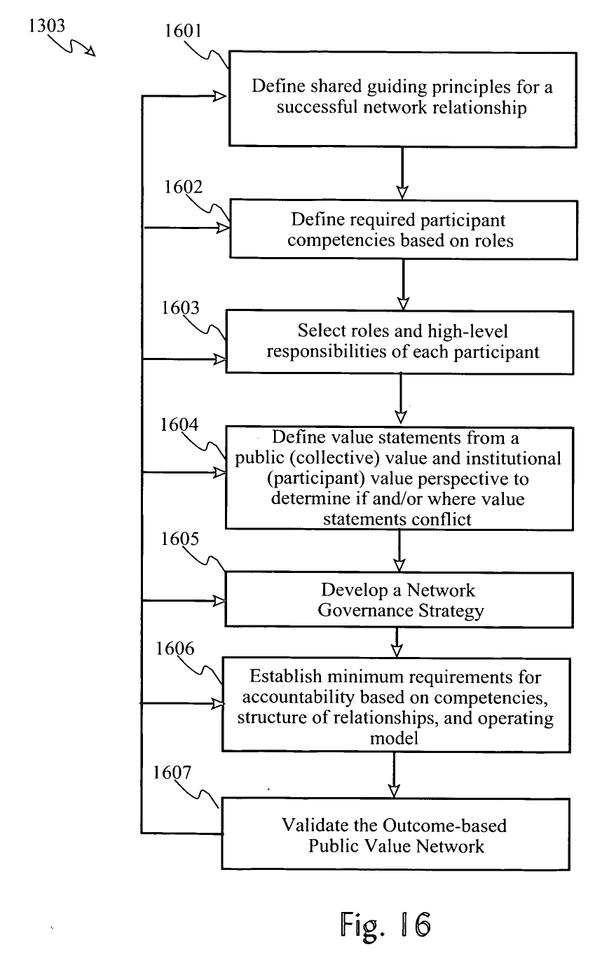

Turning to FIG. 16, a logical process according to the present invention to define or revise the network governance model includes the following steps:
(a) define shared guiding principles for a successful network relationship (1601);
(b) define required participant competencies based on roles (1602);
(c) select roles and high-level responsibilities of each participant (1603);
(d) define value statements from a public (collective) value and institutional (participant) value perspective to determine if and/or where value statements conflict (1604);
(e) develop a Network Governance Strategy (1605);
(f) establish minimum requirements for accountability based on competencies, structure of relationships, and operating model (1606); and
(g) validate the Outcome-based Public Value Network (1607).

According to the present invention, all of these steps are accomplished via a computer-aided application program, receiving input and definitions from a user, and providing any identified graphical illustrations or outputs to the user via a computer display, printed report, or equivalent.

Phase 4: Define the Public Value Network Capabilities and Assess Capability Maturity

Returning to FIG. 1, in the next phase (1304) of the overall OBD process, an optimal set of competencies is established that both organizes and bounds the public value network. Using a Network Component Business Model based on competencies. Both business components/capabilities are defined for each competency area along at least three levels:
(1) Ideas and Plans;
(2) Management and Control; and
(3) Service Delivery.

Traditional Component Business Modeling (“CBM”) techniques may be employed to determine strategic capabilities, identify gaps and to align participants to the appropriate role. For each of the strategic capabilities, this phase provides for the assessment of capability maturity using the Capability Maturity Hierarchy and the list of capability gaps to determine optimal points of intervention.

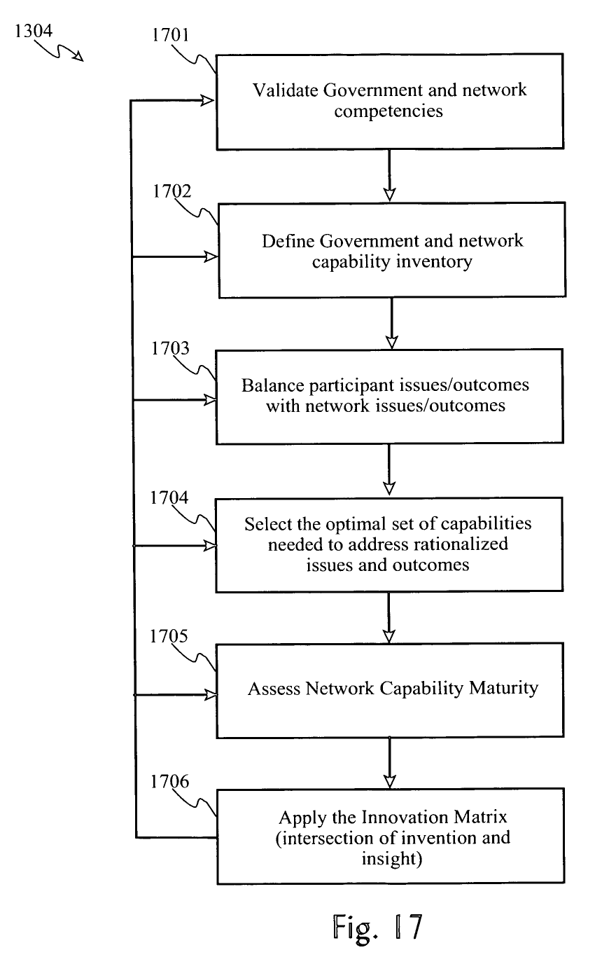

Turning to FIG. 17, a logical process according to the present invention to define or revise the public value network capabilities and assess capability maturity includes the following steps:
(a) validate government and network competencies (1701);
(b) define government and network capability inventory (1702);
(c) balance participant issues and outcomes with network issues and outcomes (1703);
(d) select the set of capabilities needed to address rationalized issues and outcomes (1704);
(e) assess network capability maturity (1705); and
(f) apply the Innovation Leadership Matrix (1706).

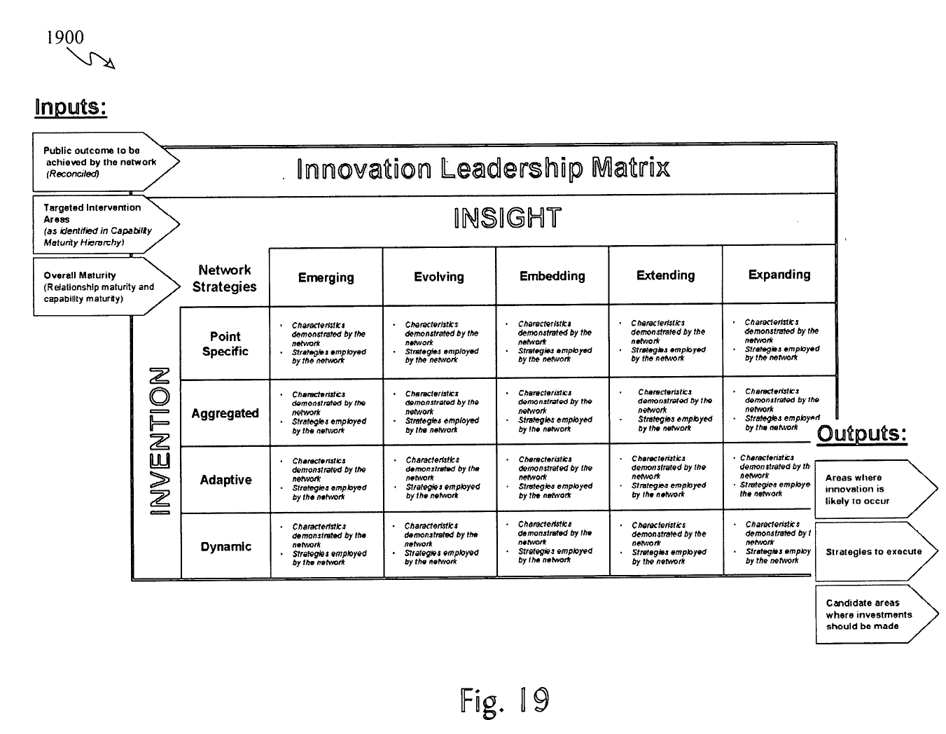

As exemplified (1900) in FIG. 19, an Innovation Leadership Matrix shows the intersection of insight and invention—to assess and guide strategy development for building an environment for innovation leadership.

According to the present invention, all of these steps, are accomplished via a computer-aided application programs, receiving input and definitions from a user, and providing any identified graphical illustrations or outputs to the user via a computer display, printed report, or equivalent.

Phase 5: Create an Outcomes-based Delivery Roadmap (1305)

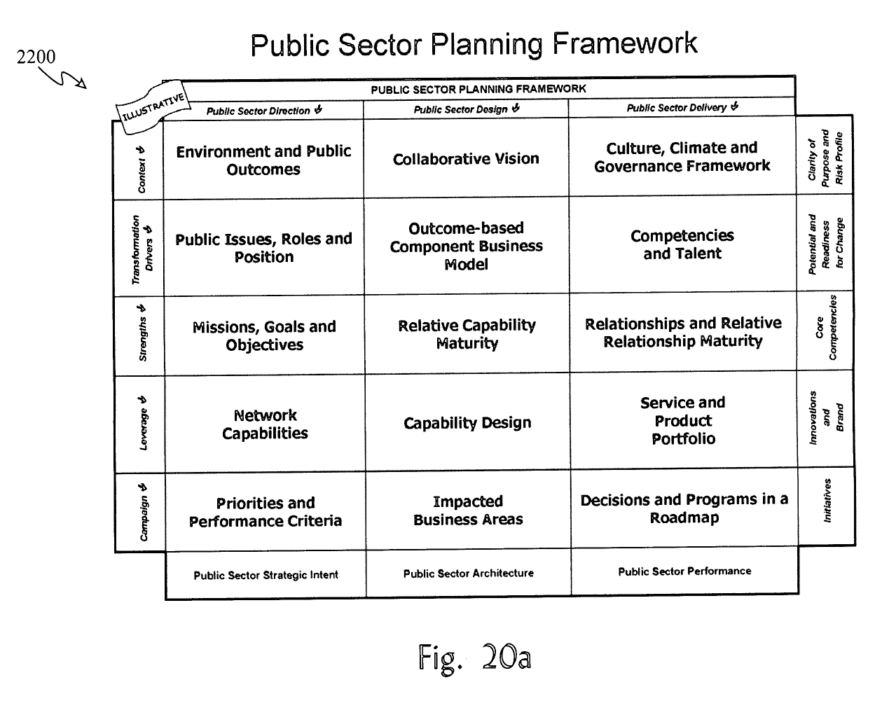

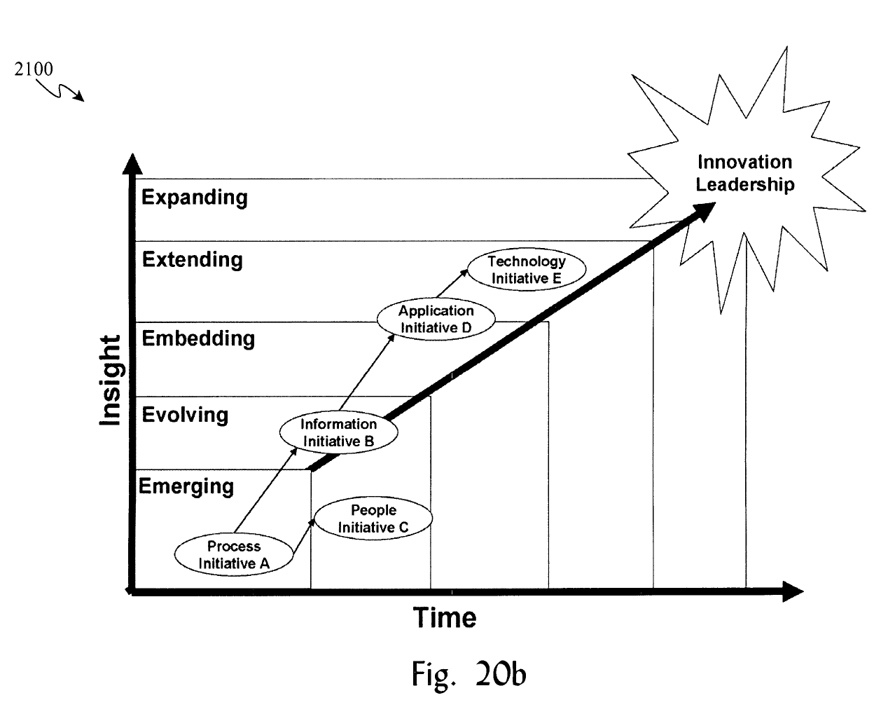

Throughout the execution of the method, the Public Sector Planning Framework provides a map for aligning desired public outcomes to a networked solution. Specifically, this phase includes building a roadmap based on activities that direct, design and deliver the appropriate solution. FIG. 20a shows an illustrative Public Sector Planning Framework (2200) that links the components of this invention with other methods, where appropriate, to guide the range of activity from public outcome to an Outcomes-based Delivery roadmap. FIG. 20b shows a example (2100) of such a roadmap display or printout.

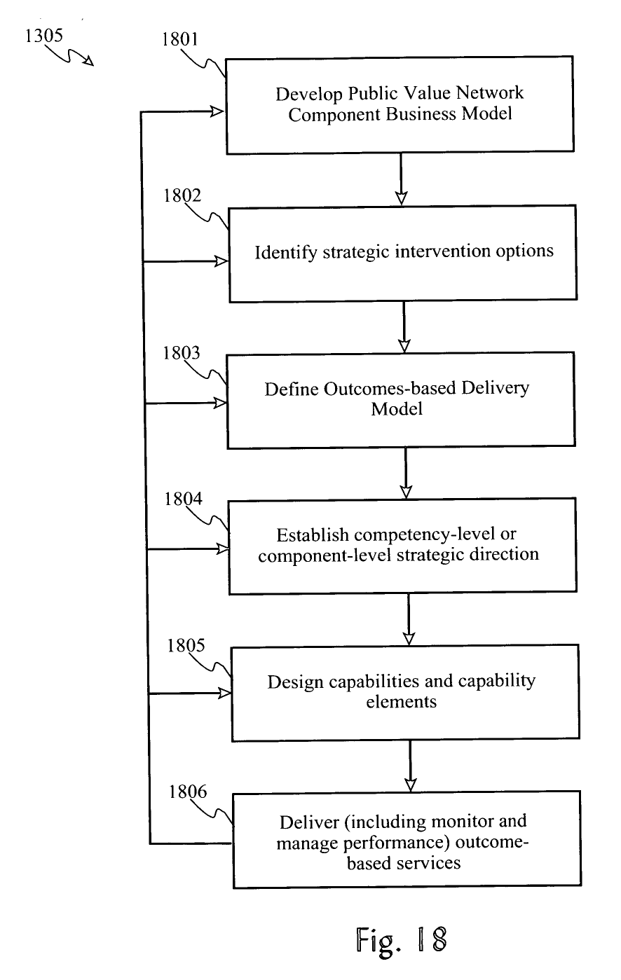

Turning to FIG. 18, a logical process according to the present invention to create an outcome delivery roadmap includes the following steps:
(a) develop Public Value Network Component Business Model (1801) using conventional CBM methods;
(b) identify strategic intervention options (1802);
(c) define Outcomes-based Delivery Model (1803);
(d) establish competency- or component-level strategic direction (1804);
(e) design capabilities and capability elements (1805);
(f) deliver (including monitor and manage performance) outcomes-based services (1806).

According to the present invention, all of these steps, are accomplished via a computer-aided application programs, receiving input and definitions from a user, and providing any identified graphical illustrations or outputs to the user via a computer display, printed report, or equivalent.

Thus, in summary, the five general phases of the present invention incorporate several major outputs including the Public Issue Map, Public Value Network, Relationship Maturity Assessment, Network Governance Framework, Network Capability Map (using CBM), Capability Maturity, and the Outcomes-based Delivery Roadmap.

Public Issue Map

To generate a public issue map, the following steps are preferably performed by the invention:
(a) defining or inputting the public issue, based on external environment and policy analysis;
(b) identifying the relevant public outcome(s);
(c) selecting the desired public outcome(s) that will be in focus;
(d) identifying the relevant public policy areas that “touch” the public outcome to guide the identification of network participants across sectors; and
(e) mapping participant institutions against the policy areas.

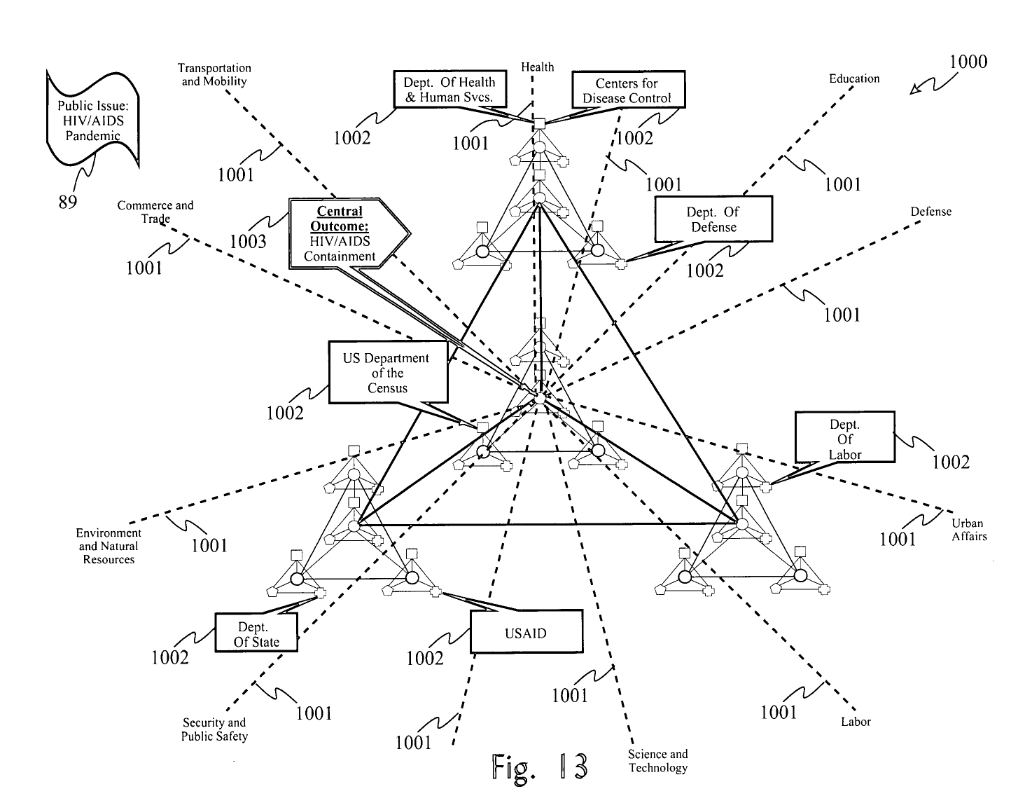

The map is preferably output in the form of a hierarchical network such as that which has been adopted from Barabasi, adapted and further defined by this invention. An example public issue map display is shown (1000) in FIG. 13 for the public issue “HIV/AIDS Pandemic”, as produced by the invention. As can be seen, following the method of the invention, this map is greatly improved over that of the existing art in level of information, number of identified participants, definition of roles, etc. In this illustration, a number of networks are shown which are all related to the central outcome of contained HIV/AIDS disease (1003), shown in a call-out box which preferably is shown when a pointer is moved over the icon (circle icon) representing the outcome.

Other call out boxes (1002) are displayed appropriately (e.g. when enabled or when a pointer is moved over them, etc.), to annotate and display each party represented by each icon in the public value network diagram, such as the regulatory and governmental agencies shown in this example. Further according to a preferred embodiment, a number of reference indicators (1001) radiating from the central outcome are shown, each having a label indicating a public policy area such as “security and public safety”, “education”, etc., as previously listed. The overall map is arranged and ordered such that the reference indicators (1001) provide a key to organizational nature of the components and participants in the public issue map (e.g. the Department of Health and Human Services appears near the reference indicator for the public policy “health”, the Department of Labor appears near the reference indicator for public policy area “labor”, etc.).

Network Governance Component

To successfully achieve the shared public outcome, such as a contained disease in our current example, the network is based on a foundation of trust. In order to promote trust within the network, the invention assesses each participant's role and the maturity of their capabilities to perform their respective roles, using the following process:
(a) articulating the primary roles that network participants play (or will play) to contribute to the desired outcome by:
   (i) identifying the natural alliances and relationships among participants; and
   (ii) identifying potential strategic alliances and relationships;
(b) determining the maturity of the relationships (e.g. have the participants collaborated often in the past, rarely, or not at all), whereas relationship maturity provides important insights on risk and where to strengthen the network's foundation of trust; and
(c) developing a Network Governance Strategy.

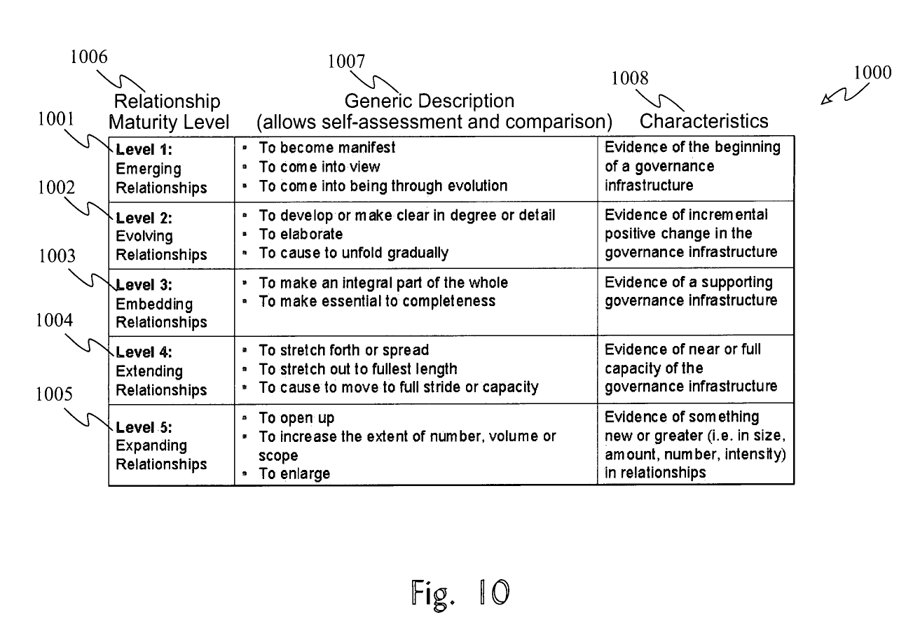

According to the preferred embodiment of the invention, relationship maturity is assessed according to the following definitions of “level” of maturity, in the order of least mature to most mature, as (1) emerging, (2) evolving, (3) embedding, (4) extending, and (5) expanding (1001 through 1005, respectively), as shown in the chart (1000) of FIG. 10. For each maturity level (1006), a description (1007) and example characteristics (1008) which evidence each level of maturity are shown. It will be recognized by those skilled in the art that these specific level of maturity definitions may be adapted to various situations as needed, and need not be exactly those shown in FIG. 10 to fall within the scope of the present invention.

According to a preferred embodiment of the invention, the enhanced display of the public value network as shown in FIG. 13 is further enhanced to include annotation regarding the relationships (shown as the solid lines between participants and between sub-networks) to indicate level of maturity. This can be done using colored lines (e.g. red for least mature, green for most mature, etc.), variations of line style (e.g. dashed for least mature, solid wide for most mature), or using pop-up or fly-over information boxes.

FIG. 11a illustrates the early steps of defining the network governance framework by articulating the primary roles that participants play in a public value network. At the same time, roles influence the business components within the public value network. This network governance table (1100) has a number of participant primary roles organized into the columns. The roles call for specific competencies which are needed to successfully fulfill the roles. The competencies are organized into sub-columns under each role. Each role will also guide the development of key performance measures and indicators.

Public Sector Planning Component

Once the roles and competencies are defined and aligned, the Component Business Model methodology may be applied, to develop the Network level component business model. In this example for the HIV/AIDS Supply Chain, several competencies are needed to effectively fulfill the roles played in the public value network which is the framework for the Component Business Modeling (“CBM”), including another identified operating level for “ideas”. The business components, which can also be viewed as “capabilities”, of the network are identified. The public sector planning component is used as a guide for defining strategic direction at the competency-level or component-level, designing related priority capabilities, and ultimately delivering services that contribute to the desired public outcome. Preferably, the public sector planning component aligns resources, methodologies such as CBM, solutions and services to relevant areas of opportunity in the public value network. In this example, a hot spot (1103) is identified and shown using a variation in text and table cell background color. Alternatively, a variety of background or text colors, styles, sizes, and patterns can be employed to illustrate one or more levels of maturity, problems and opportunities.”

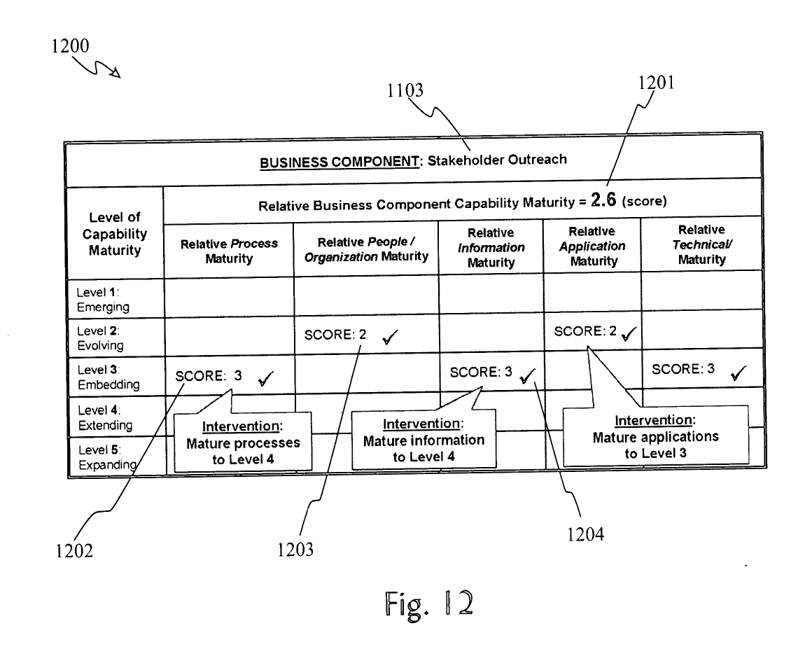

By understanding and visualizing capability maturity, developing the appropriate set of capabilities and coordinating capability interaction—the public value network is made possible. According to the present invention, each entry in the table (1102) of FIG. 11c can be viewed by the user in greater detail to enter or review the maturity level of the participants regarding that needed capability. FIG. 12 shows the detailed maturity view (1200) of a selected capability (1203) “stakeholder outreach”, along with a number of entries (1202, 1203, and 1204) for various maturity levels, which are averaged or otherwise combined into a composite score (1201) for that capability. For example, a weighted score may be applied in some embodiments of the invention instead of a straight or normal average. Optionally, icons (1204) such as check marks are displayed next to maturity ratings which exceed a preferred maturity level.

Suitable Computing Platform

The invention is preferably realized in part or in its entirety as a feature or addition to the software already found present on well-known computing platforms such as personal computers, web servers, and web browsers. These common computing platforms can include personal computers as well as portable computing platforms, such as personal digital assistants (“PDA”), web-enabled wireless telephones, and other types of personal information management (“PIM”) devices.

Therefore, it is useful to review a generalized architecture of a computing platform which may span the range of implementation, from a high-end web or enterprise server platform, to a personal computer, to a portable PDA or web-enabled wireless phone.

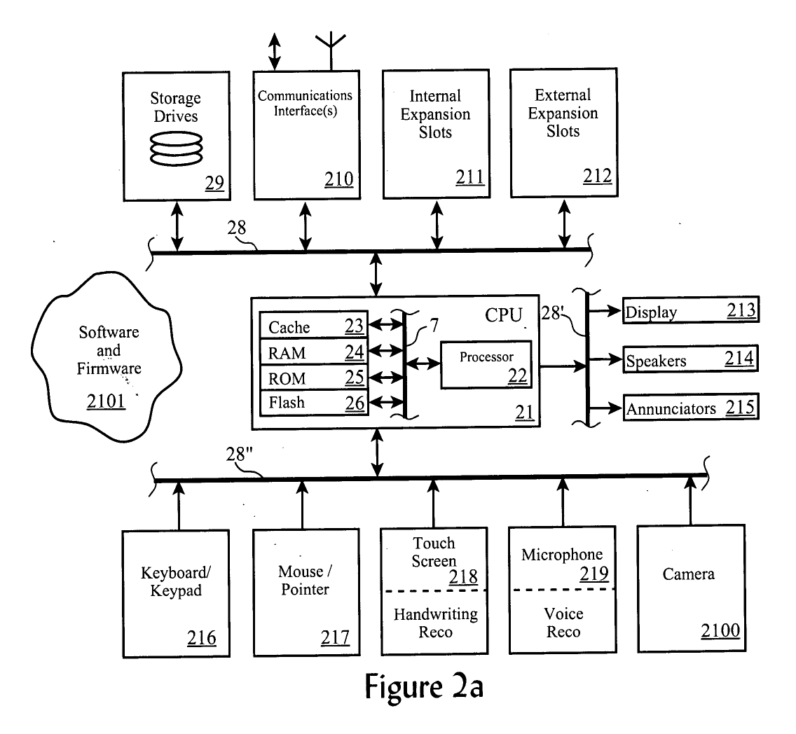

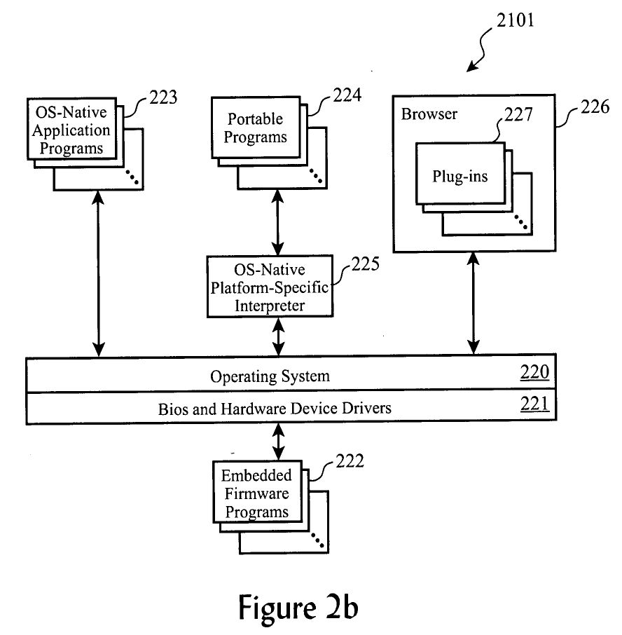

Turning to FIG. 2a, a generalized architecture is presented including a central processing unit (21) (“CPU”), which is typically comprised of a microprocessor (22) associated with random access memory (“RAM”) (24) and read-only memory (“ROM”) (25). Often, the CPU (21) is also provided with cache memory (23) and programmable FlashROM (26). The interface (27) between the microprocessor (22) and the various types of CPU memory is often referred to as a “local bus”, but also may be a more generic or industry standard bus.

Many computing platforms are also provided with one or more storage drives (29), such as a hard-disk drives (“HDD”), floppy disk drives, compact disc drives (CD, CD-R, CD-RW, DVD, DVD-R, etc.), and proprietary disk and tape drives (e.g., lomega Zip™ and Jaz™, Addonics SuperDisk™, etc.). Additionally, some storage drives may be accessible over a computer network.

Many computing platforms are provided with one or more communication interfaces (210), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (“IrDA”) interface, too.

Computing platforms are often equipped with one or more internal expansion slots (211), such as Industry Standard Architecture (“ISA”), Enhanced Industry Standard Architecture (“EISA”), Peripheral Component Interconnect (“PCI”), or proprietary interface slots for the addition of other hardware, such as sound cards, memory boards, and graphics accelerators.

Additionally, many units, such as laptop computers and PDA's, are provided with one or more external expansion slots (212) allowing the user the ability to easily install and remove hardware expansion devices, such as PCMCIA cards, SmartMedia cards, and various proprietary modules such as removable hard drives, CD drives, and floppy drives.

Often, the storage drives (29), communication interfaces (210), internal expansion slots (211) and external expansion slots (212) are interconnected with the CPU (21) via a standard or industry open bus architecture (28), such as ISA, EISA, or PCI. In many cases, the bus (28) may be of a proprietary design.

A computing platform is usually provided with one or more user input devices, such as a keyboard or a keypad (216), and mouse or pointer device (217), and/or a touch-screen display (218). In the case of a personal computer, a full size keyboard is often provided along with a mouse or pointer device, such as a track ball or TrackPoint™. In the case of a web-enabled wireless telephone, a simple keypad may be provided with one or more function-specific keys. In the case of a PDA, a touch-screen (218) is usually provided, often with handwriting recognition capabilities.

Additionally, a microphone (219), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (2100), such as a still digital camera or full motion video digital camera.

One or more user output devices, such as a display (213), are also provided with most computing platforms. The display (213) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (214) and/or annunciators (215) are often associated with computing platforms, too. The speakers (214) may be used to reproduce audio and music, such as the speaker of a wireless telephone or the speakers of a personal computer. Annunciators (215) may take the form of simple beep emitters or buzzers, commonly found on certain devices such as PDAs and PIMs.

These user input and output devices may be directly interconnected (28′, 28″) to the CPU (21) via a proprietary bus structure and/or interfaces, or they may be interconnected through one or more industry open buses such as ISA, EISA, PCI, etc.

The computing platform is also provided with one or more software and firmware (2101) programs to implement the desired functionality of the computing platforms.

Turning to now FIG. 2b, more detail is given of a generalized organization of software and firmware (2101) on this range of computing platforms. One or more operating system (“OS”) native application programs (223) may be provided on the computing platform, such as word processors, spreadsheets, contact management utilities, address book, calendar, email client, presentation, financial and bookkeeping programs.

Additionally, one or more “portable” or device-independent programs (224) may be provided, which must be interpreted by an OS-native platform-specific interpreter (225), such as Java™ scripts and programs.

Often, computing platforms are also provided with a form of web browser or micro-browser (226), which may also include one or more extensions to the browser such as browser plug-ins (227).

The computing device is often provided with an operating system (220), such as Microsoft Windows™, UNIX, IBM OS/2™, IBM AIX™, open source LINUX, Apple's MAC OS™, or other platform specific operating systems. Smaller devices such as PDA's and wireless telephones may be equipped with other forms of operating systems such as real-time operating systems (“RTOS”) or Palm Computing's PalmOS™.

A set of basic input and output functions (“BIOS”) and hardware device drivers (221) are often provided to allow the operating system (220) and programs to interface to and control the specific hardware functions provided with the computing platform.

Additionally, one or more embedded firmware programs (222) are commonly provided with many computing platforms, which are executed by onboard or “embedded” microprocessors as part of the peripheral device, such as a micro controller or a hard drive, a communication processor, network interface card, or sound or graphics card.

As such, FIGS. 2a and 2b describe in a general sense the various hardware components, software and firmware programs of a wide variety of computing platforms, including but not limited to personal computers, PDAs, PIMs, web-enabled telephones, and other appliances such as WebTV™ units. As such, we now turn our attention to disclosure of the present invention relative to the processes and methods preferably implemented as software and firmware on such a computing platform. It will be readily recognized by those skilled in the art that the methods and processes disclosed herein may be alternatively realized as hardware functions, in part or in whole, without departing from the spirit and scope of the invention.

Deployment Service for the OBD Methods and Processes

According to one embodiment of the invention, the methods and processes of the invention are distributed or deployed as a service to by a service provider to a client's computing system(s).

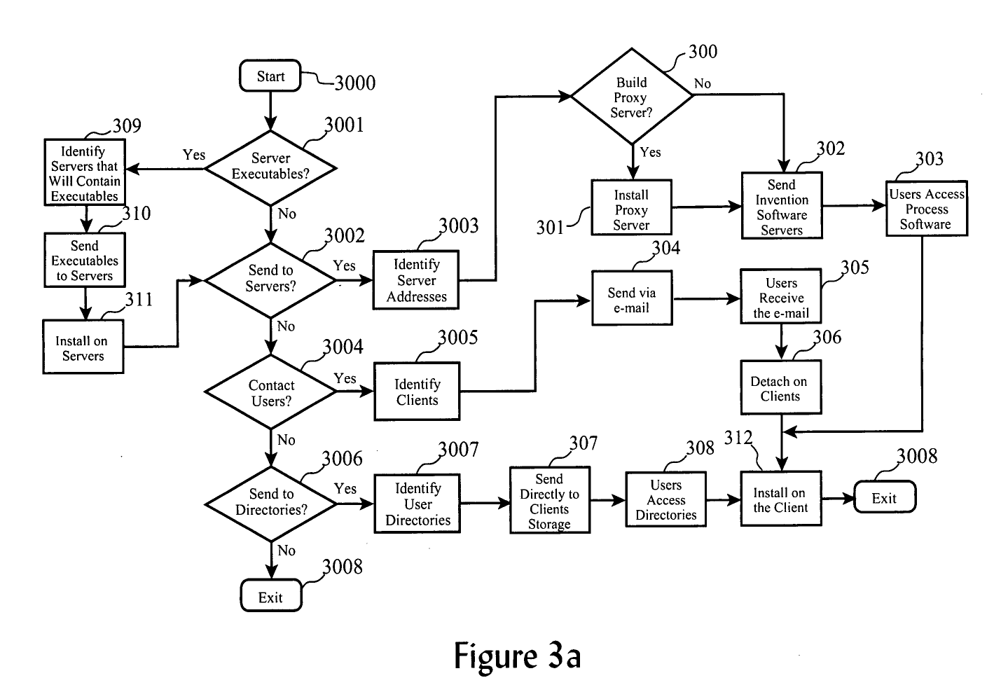

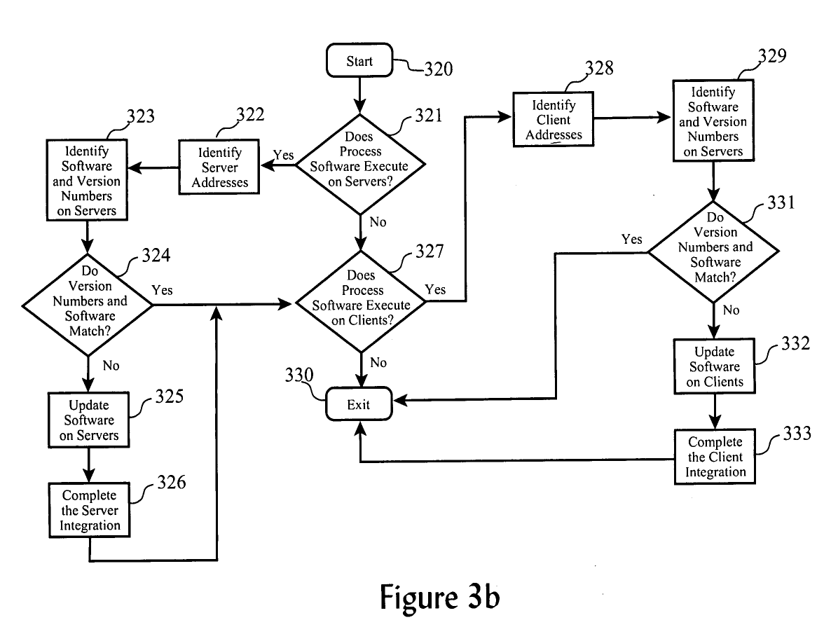

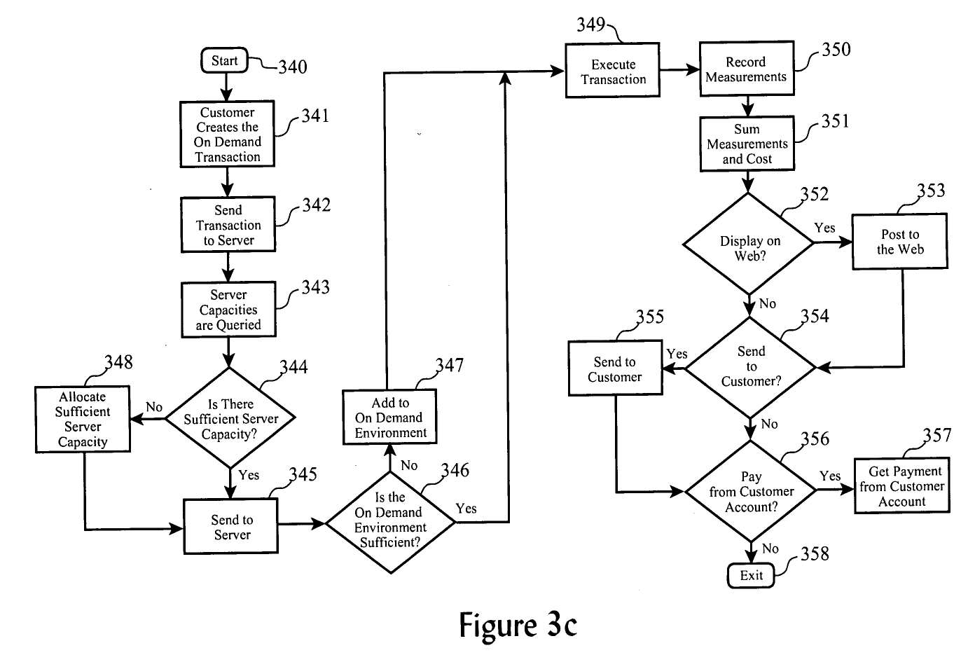

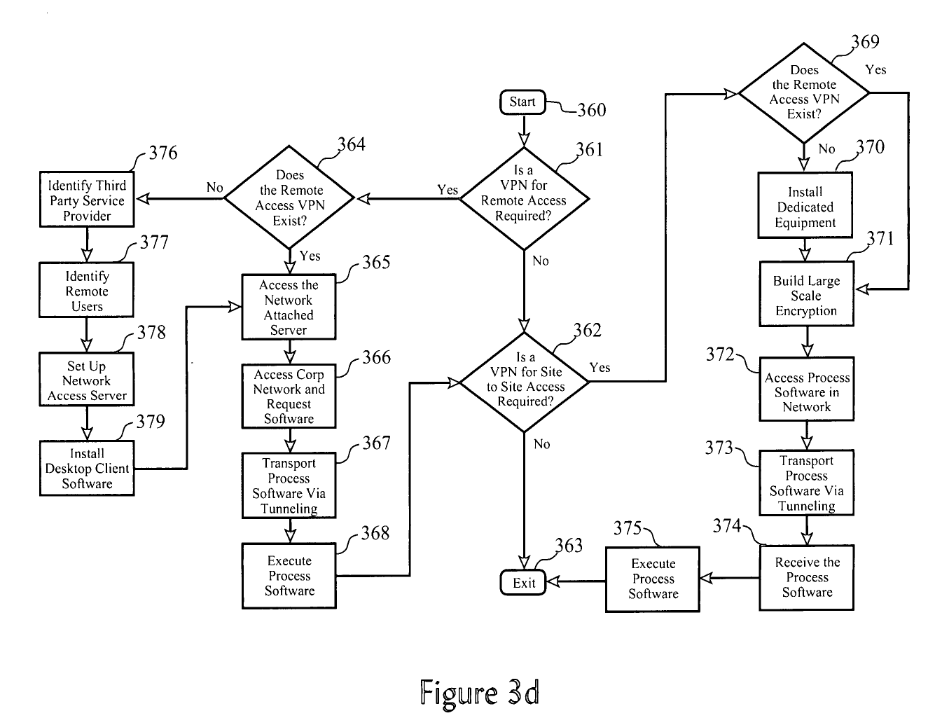

Turning to FIG. 3a, the deployment process begins (3000) by determining (3001) if there are any programs that will reside on a server or servers when the process software is executed. If this is the case then the servers that will contain the executables are identified (309). The process software for the server or servers is transferred directly to the servers storage via FTP or some other protocol or by copying through the use of a shared files system (310). The process software is then installed on the servers (311).

Next a determination is made on whether the process software is to be deployed by having users access the process software on a server or servers (3002). If the users are to access the process software on servers then the server addresses that will store the process software are identified (3003).

In step (3004) a determination is made whether the process software is to be developed by sending the process software to users via e-mail. The set of users where the process software will be deployed are identified together with the addresses of the user client computers (3005). The process software is sent via e-mail to each of the user's client computers. The users then receive the e-mail (305) and then detach the process software from the e-mail to a directory on their client computers (306). The user executes the program that installs the process software on his client computer (312) then exits the process (3008).

A determination is made if a proxy server is to be built (300) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required then the proxy server is installed (301). The process software is sent to the servers either via a protocol such as FTP or it s copied directly from the source files to the server files via file sharing (302). Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems (303). Another embodiment is to have the servers automatically copy the process software to each client and then run the installation program for the process software at each client computer. The user executes the program that installs the process software on his client computer (312) then exits the process (3008).

Lastly, a determination is made on whether the process software will be sent directly to user directories on their client computers (3006). If so, the user directories are identified (3007). The process software is transferred directly to the user's client computer directory (307). This can be done in several ways such as but not limited to sharing of the file system directories and then copying from the sender's file system to the recipient user's file system or alternatively using a transfer protocol such as File Transfer Protocol (“FTP”). The users access the directories on their client file systems in preparation for installing the process software (308). The user executes the program that installs the process software on his client computer (312) then exits the process (3008).

Integration of OBD Methods to Other Software Programs

According to another embodiment of the present invention, software embodying the methods and processes disclosed herein are integrated as a service by a service provider to other software applications, applets, or computing systems.

Integration of the invention generally includes providing for the process software to coexist with applications, operating systems and network operating systems software and then installing the process software on the clients and servers in the environment where the process software will function.

Generally speaking, the first task is to identify any software on the clients and servers including the network operating system where the process software will be deployed that are required by the process software or that work in conjunction with the process software. This includes the network operating system that is software that enhances a basic operating system by adding networking features. Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

Turning to FIG. 3b, details of the integration process according to the invention are shown. Integrating begins (320) by determining if there are any process software programs that will execute on a server or servers (321). If this is not the case, then integration proceeds to (327). If this is the case, then the server addresses are identified (322). The servers are checked to see if they contain software that includes the operating system (“OS”), applications, and network operating systems (“NOS”), together with their version numbers, that have been tested with the process software (323). The servers are also checked to determine if there is any missing software that is required by the process software (323).

A determination is made if the version numbers match the version numbers of OS, applications and NOS that have been tested with the process software (324). If all of the versions match and there is no missing required software the integration continues in (327).

If one or more of the version numbers do not match, then the unmatched versions are updated on the server or servers with the correct versions (325). Additionally if there is missing required software, then it is updated on the server or servers (325). The server integration is completed by installing the process software (326).

Step (327) which follows either (321), (324), or (326) determines if there are any programs of the process software that will execute on the clients. If no process software programs execute on the clients the integration proceeds to (330) and exits. If this is not the case, then the client addresses are identified (328).

The clients are checked to see if they contain software that includes the operating system (“OS”), applications, and network operating systems (“NOS”), together with their version numbers, that have been tested with the process software (329). The clients are also checked to determine if there is any missing software that is required by the process software (329).

A determination is made if the version numbers match the version numbers of OS, applications and NOS that have been tested with the process software 331. If all of the versions match and there is no missing required software, then the integration proceeds to (330) and exits.

If one or more of the version numbers do not match, then the unmatched versions are updated on the clients with the correct versions (332). In addition, if there is missing required software then it is updated on the clients (332). The client integration is completed by installing the process software on the clients (333). The integration proceeds to (330) and exits.

Providing OBD as an On-Demand Computing Service

According to another aspect of the present invention, the processes and methods disclosed herein are provided through an on-demand computing architecture to render service to a client by a service provider.

Turning to FIG. 3c, generally speaking, the process software embodying the methods disclosed herein is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions, etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to effect the performance of that server, other servers are accessed to increase the capacity and to share the workload. Likewise when other measurements of use such as network bandwidth, memory usage, storage usage, etc. approach a capacity so as to effect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the computer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

FIG. 3c sets forth a detailed logical process which makes the present invention available to a client through an On-Demand process. A transaction is created that contains the unique customer identification, the requested service type and any service parameters that further specify the type of service (341). The transaction is then sent to the main server (342). In an On Demand environment the main server can initially be the only server, then as capacity is consume other servers are added to the On Demand environment.

The server central processing unit (“CPU”) capacities in the On Demand environment are queried (343). The CPU requirement of the transaction is estimated, then the servers available CPU capacity in the On Demand environment are compared to the transaction CPU requirement to see if there is sufficient CPU available capacity in any server to process the transaction (344). If there is not sufficient server CPU available capacity, then additional server CPU capacity is allocated to process the transaction (348). If there was already sufficient available CPU capacity then the transaction is sent to a selected server (345).

Before executing the transaction, a check is made of the remaining On Demand environment to determine if the environment has sufficient available capacity for processing the transaction. This environment capacity consists of such things as but not limited to network bandwidth, processor memory, storage etc. (345). If there is not sufficient available capacity, then capacity will be added to the On Demand environment (347). Next the required software to process the transaction is accessed, loaded into memory, then the transaction is executed (349).

The usage measurements are recorded (350). The usage measurements consists of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (351).

If the customer has requested that the On Demand costs be posted to a web site (352) then they are posted (353). If the customer has requested that the On Demand costs be sent via e-mail to a customer address (354) then they are sent (355). If the customer has requested that the On Demand costs be paid directly from a customer account (356) then payment is received directly from the customer account (357). The last step is to exit the On Demand process.

Deployment of the OBD Processes via a VPN

According to another aspect of the present invention, the methods and processes described herein may be embodied in part or in entirety in software which can be deployed to third parties as part of a service, wherein a third party VPN service is offered as a secure deployment vehicle or wherein a VPN is build on-demand as required for a specific deployment.

A virtual private network (“VPN”) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (“ESP”) sets a network access server (“NAS”) and provides the remote users with desktop client software for their computers. The telecommuters can then dial a toll-free number to attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a companies multiple fixed sites over a public network such as the Internet.

The process software is transported over the VPN via tunneling which is the process of placing an entire packet within another packet and sending it over the network. The protocol of the outer packet is understood by the network and both points, called tunnel interfaces, where the packet enters and exits the network.

Turning to FIG. 3d, VPN deployment process starts (360) by determining if a VPN for remote access is required (361). If it is not required, then proceed to (362). If it is required, then determine if the remote access VPN exits (364).

If a VPN does exist, then the VPN deployment process proceeds (365) to identify a third party provider that will provide the secure, encrypted connections between the company's private network and the company's remote users (376). The company's remote users are identified (377). The third party provider then sets up a network access server (“NAS”) (378) that allows the remote users to dial a toll free number or attach directly via a broadband modem to access, download and install the desktop client software for the remote-access VPN (379).

After the remote access VPN has been built or if it has been previously installed, the remote users can access the process software by dialing into the NAS or attaching directly via a cable or DSL modem into the NAS (365). This allows entry into the corporate network where the process software is accessed (366). The process software is transported to the remote user's desktop over the network via tunneling. That is the process software is divided into packets and each packet including the data and protocol is placed within another packet (367). When the process software arrives at the remote user's desktop, it is removed from the packets, reconstituted and then is executed on the remote users desktop (368).

A determination is made to see if a VPN for site to site access is required (362). If it is not required, then proceed to exit the process (363). Otherwise, determine if the site to site VPN exists (369). If it does exist, then proceed to (372). Otherwise, install the dedicated equipment required to establish a site to site VPN (370). Then build the large scale encryption into the VPN (371).

After the site to site VPN has been built or if it had been previously established, the users access the process software via the VPN (372). The process software is transported to the site users over the network via tunneling. That is the process software is divided into packets and each packet including the data and protocol is placed within another packet (374). When the process software arrives at the remote user's desktop, it is removed from the packets, reconstituted and is executed on the site users desktop (375). Proceed to exit the process (363).

Conclusion

The present invention has been disclosed accompanied with several embodiments and alternative features, relative to preferred design choices including specific programming methodologies, languages, computing platforms, and detailed processes. It will be recognized by those skilled in the art, however, that alternative embodiments may be realized without departing from the spirit and scope of the present invention. Therefore, the scope of the present invention should be determined by the following claims.

What is claimed is:

1. A method for defining and managing a public value network according to one or more desired outcomes of the public value network, comprising the steps of:
creating a public value network representation by defining and mapping a public issue against a public policy system to the desired public outcome;
assessing maturity levels of relationships between public value network participants by assigning a maturity level value to each relationship;
establishing a network governance framework;
defining or revising one or more public value network capabilities while assessing capability maturity;
creating or updating an outcome delivery roadmap; and
creating one or more visualizations displayed to a user representing said network, said relationships, said maturity levels, and said roadmap.

2. The method as set forth in claim 1 wherein said step of creating a public value network representation comprises creating a public issue map by mapping a specific public issue against the public policy system to said desired public outcome.

3. The method as set forth in claim 2 further comprising performing an environmental and public policy analysis.

4. The method as set forth in claim 2 wherein said step of creating a public issue map comprises the steps of:
(a) identifying and defining one or public issues;
(b) identifying one or more public outcomes to which the public issue(s) points;
(c) mapping said public issues against a public policy system;
(d) identifying one or more cross-sector participants involved with contributing to said public outcomes;
(e) identifying cross-sector non-participants that are likely to become future participants; and
(f) identifying shared and complementary benefits for said participants.

5. The method as set forth in claim 1 wherein said step of assessing maturity of said relationships by assigning a maturity level value to each relationship further comprises:
(a) identifying and defining one or more current or desired roles played by each participant in contributing to said outcomes;
(b) categorizing said roles according to one or more role categories;
(c) identifying and defining existing relationships between participants or type of network between said participants;
(d) assessing the maturity of the existing relationships to determine the ease with which of these parties work together to achieve the public outcome;
(e) articulating participant challenges, problems and opportunities in narrative form; and
(f) defining an Outcome-based Public Value Network.

6. The method as set forth in claim 5 wherein said step of categorizing said roles according to one or more role categories comprises categorizing using a category selected from the group of “Mission-critical”, “Mission-relevant”, “Differentiating”; “Non-Mission critical”, and “Commoditized”.

7. The method as set forth in claim 1 wherein said step of establishing a network governance framework further comprises the steps of:
(a) defining one or more shared guiding principles for a successful network relationship;
(b) defining one or more required participant competencies based on roles;
(c) selecting one or more roles or high-level responsibilities of each participant;
(d) defining one or more value statements from a public (collective) value and institutional (participant) value perspective to determine if and/or where value statements conflict;
(e) developing a Network Governance Strategy;
(f) establishing one or more minimum requirements for accountability based on competencies, structure of relationships, and operating model; and
(g) validating an Outcome-based Public Value Network.

8. The method as set forth in claim 7 wherein said steps of specifying a plurality of capabilities of said public value network and calculating capabilities maturity indices comprise establishing a set of competencies that organize and bound the public value network using a network Component Business Model according to competencies, business components, capabilities for each competency area along at least three levels of responsibility comprising (a) plans, (b) management and control, and (c) service delivery.

9. The method as set forth in claim 1 wherein said step of defining or revising one or more public value network capabilities while assessing capability maturity comprises:
(a) validating one or more government and network competencies;
(b) defining government and network capability inventory;
(c) balancing participant issues and outcomes with network issues and outcomes;
(d) selecting a set of capabilities needed to address rationalized issues and outcomes;
(e) assessing network capability maturity; and I
(f) applying an innovation leadership matrix showing the intersection of invention and insight.

10. The method as set forth in claim 1 wherein said step of creating or updating an outcome delivery roadmap comprises:
(a) developing a Public Value Network Component Business Model using conventional CBM methods;
(b) identifying zero or more strategic intervention options;
(c) defining an Outcomes-based Delivery Model;
(d) establishing competency-level or component-level strategic direction;
(e) designing capabilities and capability elements; and
(f) delivering outcome-based services according to said delivery roadmap.

11. The method as set forth in claim 1 wherein said step of creating one or more visualizations displayed to a user representing said network, said relationships, and said maturity levels, further comprises producing an enhanced public issue map in a graphical form in which each participant is represented by a graphical element, each of said participant graphical elements are arranged essentially concentrically around a graphical element representing a desired outcome of said public value network, and including one or more linear elements representing said relationships extend between participant graphic elements and between said desired outcome graphic element, and wherein said visualization is enhanced to include annotation regarding one or more public value network characteristics selected from the group of a relationship maturity level, a capability maturity index, a composite network maturity index, and an annotation regarding a maturity index with falls below a minimum maturity level

12. A computer-readable medium encoded with software for defining and managing a public value network according to one or more desired outcomes of the public value network, said software performing the steps of:
creating a public value network representation by defining and mapping a public issue against a public policy system to the desired public outcome;
assessing maturity levels of relationships between public value network participants by assigning a maturity level value to each relationship;
establishing a network governance framework;
establishing a network governance framework;
defining or revising one or more public value network capabilities while assessing capability maturity;
creating or updating an outcome delivery roadmap; and
creating one or more visualizations displayed to a user representing said network, said relationships, said maturity levels, and said roadmap.

13. The computer-readable medium as set forth in claim 12 wherein said software for creating a public value network representation comprises software for creating a public issue map by mapping a specific public issue against the public policy system to said desired public outcome.

14. The computer-readable medium as set forth in claim 13 further comprising software for performing an environmental and public policy analysis.

15. The computer-readable medium as set forth in claim 13 wherein said software for creating a public issue map further comprises software for:
(a) identifying and defining one or public issues;
(b) identifying one or more public outcomes to which the public issue(s) points;
(c) mapping said public issues against a public policy system;
(d) identifying one or more cross-sector participants involved with contributing to said public outcomes;
(e) identifying cross-sector non-participants that are likely to become future participants; and
(f) identifying shared and complementary benefits for said participants.

16. The computer-readable medium as set forth in claim 12 wherein said software for assessing maturity of said relationships by assigning a maturity level value to each relationship further comprises software for:
(a) identifying and defining one or more current or desired roles played by each participant in contributing to said outcomes;
(b) categorizing said roles according-to one or more role categories;
(c) identifying and defining existing relationships between participants or type of network between said participants;
(d) assessing the maturity of the existing relationships to determine the ease with which of these parties work together to achieve the public outcome;
(e) articulating participant challenges, problems and opportunities in narrative form; and
(f) defining an Outcome-based Public Value Network.

17. The computer-readable medium as set forth in claim 16 wherein said software for categorizing said roles according to one or more role categories comprises software for categorizing using a category selected from the group of “Mission-critical”, “Mission-relevant”, “Differentiating”; “Non-Mission critical”, and “Commoditized”.

18. The computer-readable medium as set forth in claim 12 wherein said software for establishing a network governance framework further comprises software for:
(a) defining one or more shared guiding principles for a successful network relationship;
(b) defining one or more required participant competencies based on roles;
(c) selecting one or more roles or high-level responsibilities of each participant;
(d) defining one or more value statements from a public (collective) value and institutional (participant) value perspective to determine if and/or where value statements conflict;
(e) developing a Network Governance Strategy;
(f) establishing one or more minimum requirements for accountability based on competencies, structure of relationships, and operating model; and
(g) validating an Outcome-based Public Value Network.

19. The computer-readable medium as set forth in claim 18 wherein said software for specifying a plurality of capabilities of said public value network and calculating capabilities maturity indices comprises software for establishing a set of competencies that organize and bound the public value network using a network Component Business Model according to competencies, business components, capabilities for each competency area along at least three levels of responsibilities comprising (a) ideas and plans, (b) management and control, and (c) service delivery.

20. The computer-readable medium as set forth in claim 12 wherein said software for defining or revising one or more public value network capabilities while assessing capability maturity comprises software for:
(a) validating one or more government and network competencies;
(b) defining government and network capability inventory;
(c) balancing participant issues and outcomes with network issues and outcomes;
(d) selecting a set of capabilities needed to address rationalized issues and outcomes;
(e) assessing network capability maturity; and
(f) applying an innovation leadership matrix showing the intersection of invention and insight.

21. The computer-readable medium as set forth in claim 12 wherein said software for creating or updating an outcome delivery roadmap comprises software for:
(a) developing a Public Value Network Component Business Model using conventional CBM methods;
(b) identifying zero or more strategic intervention options;
(c) defining an Outcomes-based Delivery Model;
(d) establishing competency-level or component-level strategic direction;
(e) designing capabilities and capability elements; and
(f) delivering outcome-based services according to said delivery roadmap.

22. The computer-readable medium as set forth in claim 12 wherein said software for creating one or more visualizations displayed to a user representing said network, said relationships, and said maturity levels, further comprises software for producing an enhanced public issue map in a graphical form in which each participant is represented by a graphical element, each of said participant graphical elements are arranged essentially concentrically around a graphical element representing a desired outcome of said public value network, and including one or more linear elements representing said relationships extend between participant graphic elements and between said desired outcome graphic element, and wherein said visualization is enhanced to include annotation regarding one or more public value network characteristics selected from the group of a relationship maturity level, a capability maturity index, a composite network maturity index, and an annotation regarding a maturity index with falls below a minimum maturity Level.

23. A system for defining and managing a public value network according to one or more desired outcomes of the public value network, comprising:
a mapper adapted to create a public value network representation by defining and mapping a public issue against a public policy system to the desired public outcome;
a maturity level assigner adapted to record an assessment of maturity levels of relationships between public value network participants by assigning
a maturity level value to each relationship;
a network governance framework establisher;
one or more public value network capabilities definitions associated with assessed capability maturities;
an outcome delivery roadmap generator; and
a user output for creating one or more visualizations displayed to a user representing said network, said relationships, said maturity levels, and said roadmap.

24. The system as set forth in claim 23 wherein said mapper is further adapted to create a public issue map by mapping a specific public issue against the public policy system to said desired public outcome.

25. The system as set forth in claim 24 wherein said mapper is further adapted to perform an environmental and public policy analysis.

26. The system as set forth in claim 24 further wherein said mapper is further adapted to:
(a) identify and defining one or public issues;
(b) identify one or more public outcomes to which the public issue(s) points;
(c) map said public issues against a public policy system;
(d) identify one or more cross-sector participants involved with contributing to said public outcomes;
(e) identify cross-sector non-participants that are likely to become future participants; and
(f) identify shared and complementary benefits for said participants.

27. The system as set forth in claim 23 wherein maturity level assessor is further adapted to assess maturity of said relationships by assigning a maturity level value to each relationship by:
(a) identifying and defining one or more current or desired roles played by each participant in contributing to said outcomes;
(b) categorizing said roles according to one or more role categories;
(c) identifying and defining existing relationships between participants or type of network between said participants;
(d) assessing the maturity of the existing relationships to determine the ease with which of these parties work together to achieve the public outcome;
(e) articulating participant challenges, problems and opportunities in narrative form; and
(f) defining an Outcome-based Public Value Network.

28. The system as set forth in claim 27 wherein categorizing said roles according to one or more role categories comprises categorizing using a category selected from the group of “Mission-critical”, “Mission-relevant”, “Differentiating”; “Non-Mission critical”, and “Commoditized”.

29. The system as set forth in claim 23 wherein said network governance framework establisher is further adapted to:
(a) define one or more shared guiding principles for a successful network relationship;
(b) define one or more required participant competencies based on roles;
(c) select one or more roles or high-level responsibilities of each participant;
(d) define one or more value statements from a public (collective) value and institutional (participant) value perspective to determine if and/or where value statements conflict;
(e) develop a Network Governance Strategy;
(f) establish one or more minimum requirements for accountability based on competencies, structure of relationships, and operating model; and
(g) validate an Outcome-based Public Value Network.

30. The system as set forth in claim 29 wherein said network governance framework establisher is further adapted to specify a plurality of capabilities of said public value network and to calculate capabilities maturity indices by establishing a set of competencies that organize and bound the public value network using a network Component Business Model according to competencies, business components, capabilities for each competency area along at least three levels of responsibility comprising (a) ideas and plans, (b) management and control, and (c) service delivery.

31. The system as set forth in claim 23 wherein said network capabilities definitions are defined by steps comprising:
(a) validating one or more government and network competencies;
(b) defining government and network capability inventory;
(c) balancing participant issues and outcomes with network issues and outcomes;
(d) selecting a set of capabilities needed to address rationalized issues and outcomes;
(e) assessing network capability maturity; and
(f) applying an innovation leadership matrix showing the intersection of invention and insight.

32. The system as set forth in claim 23 wherein said outcome delivery roadmap generator is adapted to:
(a) develop a Public Value Network Component Business Model using conventional CBM methods;
(b) identify zero or more strategic intervention options;
(c) define an Outcomes-based Delivery Model
(d) establish competency-level or component-level strategic direction;
(e) design capabilities and capability elements; and
(f) deliver outcome-based services.

33. The system set forth in claim 23 wherein said user output is further adapted to produce an enhanced public issue map in a graphical form in which each participant is represented by a graphical element, each of said participant graphical elements are arranged essentially concentrically around a graphical element representing a desired outcome of said public value network, and including one or more linear elements representing said relationships extend between participant graphic elements and between said desired outcome graphic element, and wherein said visualization is enhanced to include annotation regarding one or more public value network characteristics selected from the group of a relationship maturity level, a capability maturity index, a composite network maturity index, and an annotation regarding a maturity index with falls below a minimum maturity level

34. A method for conducting a transaction in an on-demand computing environment comprising the steps of:
providing transaction-oriented process software in a shared file system to:
(a) create a public value network representation by defining and mapping a public issue against a public policy system to the desired public outcome;
(b) assess maturity levels of relationships between public value network participants by assigning a maturity level value to each relationship;
(c) establish a network governance framework;
(d) define or revise one or more public value network capabilities while assessing capability maturity;
(e) create or update an outcome delivery roadmap; and
(f) create one or more visualizations displayed to a user representing said network, said relationships, said maturity levels, and said roadmap;
executing said process software in an on-demand computing system wherein the transactions provided by said process software are automatically shared by simultaneously serving multiple customers;
differentiating and recording each customer's usage of said process software according to one or more parameters included in said transactions, said parameters uniquely identifying each customer and a type of transaction conducted for that customer.
responsive to a number of simultaneous transactions to any one server exceeding a performance limit of a given server, automatically accessing one or more additional servers to increase the capacity and to share the workload;

35. The method as set forth in claim 34 further comprising providing transaction processing capacity to at least one customer using a pay-as-you-go model in which charges are posted for actual computing resource consumption.

36. The method as set forth in claim 35 wherein with resource consumption is metered in at least one unit selected from the group of processor units of time, processor operations, number of transactions completed, network bandwidth utilized, memory usage, storage usage, and number of communications packet transfers completed.

37. The method as set forth in claim 35 wherein said pay-as-you-go model further comprises automatically requesting payment by a service provider directly from a customer account at a banking or financial institution.

38. The method as set forth in claim 35 further comprising:
collecting by a billing server from a transaction server one or more service consumption measurements for a customer;
periodically summing said collected measurements for said customer;
multiplying said summed measurements by a unit cost factor to yield a total process software application service cost for said customer; and
posting said total process software application service cost to said customer for payment collection.

39. The method as set forth in claim 34 wherein said step of automatically accessing one or more additional servers to increase the capacity and to share the workload is further responsive to exceeding a measured aggregate capacity limit of a server selected from the group of maximum network bandwidth, maximum memory usage, and maximum storage usage.

40. A method for deploying and using a virtual private network for controlling the flow of private reply messages responsive to a broadcast message in a messaging system, said method comprising:
responsive to determining if remote access to broadcast-with-private-reply software, transmitting said software to a client via an unsecure network using secure tunneling; responsive to determining if site access to said software is required, transmitting said software to a client via an unsecure network using secure tunneling; and
executing said software by said client to perform the steps of:
(a) create a public value network representation by defining and mapping a public issue against a public policy system to the desired public outcome;
(b) assess maturity levels of relationships between public value network participants by assigning a maturity level value to each relationship;
(c) establish a network governance framework;
(d) define or revise one or more public value network capabilities while assessing capability maturity;
(e) create or update an outcome delivery roadmap; and
(f) create one or more visualizations displayed to a user representing said network, said relationships, said maturity levels, and said roadmap.
